(19) United States
(12) Patent Application Publication
(10) Pub. No.: US 2017/0055110 A1
(43) Pub. Date: Feb. 23, 2017

(54) SYSTEMS, APPARATUS, AND METHODS RELATING TO A WEARABLE ELECTRONIC HUB FOR PERSONAL COMPUTING

(71) Applicant: NEPTUNE COMPUTER INC., Montreal (CA)

(72) Inventors: Simon TIAN, Montreal (CA); Mladen BARBARIC, Ottawa (CA)

(21) Appl. No.: 15/307,397

(22) PCT Filed: Apr. 28, 2015
(86) PCT No.: PCT/IB2015/001471

§ 371 Date: Oct. 28, 2016

Related U.S. Application Data
(60) Provisional application No. 61/985,929, filed on Apr. 29, 2014.
(60) Provisional application No. 62/103,548, filed on Jan. 14, 2015.
(60) Provisional application No. 62/015,144, filed on Jun. 20, 2014.
(60) Provisional application No. 61/985,393, filed on Apr. 28, 2014.

(51) Int. Cl. H04W 4/00

(52) U.S. Cl. CPC H04W 4/008; H04B 1/385

(57) ABSTRACT

Systems, apparatus, and methods are disclosed for personal computing enhanced by a wearable electronic hub device for wirelessly coupling with an electronic satellite device to increase portability, versatility, efficiency, and security. A wearable electronic hub device retains the most important, expensive, and personal aspects of computing, whereas electronic satellite devices, including dummy screen devices of various sizes, can be shared, lost, stolen, and/or replaced without the same security risks and expenses associated with the duplicative hardware components and personal information retained in current smartphones, tablet computers, laptop computers, etc. Accordingly, a new hardware ecosystem is disclosed that replaces the current paradigm of multiple and separate computing devices by altogether bypassing the tradeoff between portability and screen size and allowing objects everywhere to become smart by first becoming “dumb.”

### CROSS-REFERENCE TO RELATED APPLICATIONS

The present application claims a priority benefit to U.S. provisional patent application Ser. No. 61/985,393, entitled “Intelligent Wearable Data Processing and Control Platform apparatuses, Methods and Systems,” filed on Apr. 28, 2014.

The present application also claims a priority benefit to U.S. provisional patent application Ser. No. 61/985,929, entitled “Client Component Integrated Portal apparatuses, Methods and Systems,” filed on Apr. 29, 2014.

The present application also claims a priority benefit to U.S. provisional patent application Ser. No. 62/015,144, entitled “Wearable Device Based Social Connection Platform apparatuses, Methods and Systems,” filed on Jun. 20, 2014.

The present application also claims a priority benefit to U.S. provisional patent application Ser. No. 62/103,548, entitled “Wearable Data Processing and Control Platform Methods and Systems,” filed on Jan. 14, 2015.

### TECHNICAL FIELD

The present disclosure relates generally to systems, apparatus, and methods for personal computing. More specifically, the present disclosure relates to systems, apparatus, and methods relating to a wearable electronic hub device and/or a satellite device with enhanced portability, versatility, efficiency, and security.

### BACKGROUND

Consumers are currently inundated with all different types and sizes of intelligent electronic devices, including, for example, smartphones, tablet computers, notebook or laptop computers, desktop computers, and smart television sets. The increasing variety of intelligent electronic devices is intended, in part, to provide users functionality for different purposes in a variety of different environments. For example, a smartphone provides a user with access to telephone and computer processing functions while remaining mobile, whereas a tablet computer, while also portable, provides a user with a larger screen than a smartphone, but may be awkward for placing telephone calls. Similarly, a portable notebook or laptop computer provides a user with a larger screen than a smartphone, but also enhances word processing applications, for example, with a built-in keyboard. Meanwhile, a desktop computer or smart television may provide an even larger screen, particularly for viewing media, but is not as easily portable due to size, weight, etc.

Each of these devices is not only expensive and duplicative in its computing components, but also personal to its user. That is, each device stores various forms of personal information, such as user profiles, applications, files, libraries, etc. Efforts have been made to provide syncing between devices so that a user may have access to the same personal information regardless of the device at hand by uploading personal information to another device or cloud server and/or downloading personal information from another device or cloud server. However, these efforts are limited by network connectivity requirements and differences in operating systems and/or applications. As a result, if a device is lost or stolen, personal information may also be lost if syncing has not occurred and/or stolen if device security is breached. To avoid a security breach, each device further may rely on a specific and/or different user authentication protocol.

### SUMMARY

The inventor recognized that despite the flooded device market, current electronic device producers are making duplicative devices with no significant differences beyond size and/or portability. The inventor also recognized that, because screen size is indirectly related to portability, a different hardware ecosystem that combines portability with larger screen sizes would greatly benefit consumers. The inventor further recognized that the most portable device possible is a wearable device. Instead of trying to maximize screen size on a wearable device, the inventor recognized and appreciated that a wearable smart device may be paired with interchangeable “dummy” screen devices with varying sizes.

According to some embodiments, a wearable device is an electronic hub device comprising the most important, expensive, and personal aspects of computing, whereas the dummy screen devices are electronic satellite devices that can be shared, lost, stolen, and/or replaced without the same security risks and expenses associated with the duplicative hardware components and personal information in current smartphones, tablet computers, laptop computers, and other devices. Such satellite devices do not need to sync with another device or server because the same computing hub device is always being used. The satellite devices may be agnostic as to the operating system of the hub device. In some embodiments, a hub device allows a user to start an application on one satellite device screen then seamlessly transition to another satellite device screen. Because the hub device retains all personal computing information, a satellite device does not need to retain any personal data and has smaller memory and/or energy requirements. Consequently, these satellite devices may be lighter, thinner, less expensive, easier to design and manufacture, and easier to aggregate and/or integrate with different environments. For example, one or more satellite devices may be kept in a user's home, office, car, etc., so that the user only needs to carry the wearable hub device and nothing else. Accordingly, the inventor recognized and appreciated a new hardware ecosystem that replaces the current paradigm of multiple and separate computing devices by altogether bypassing the tradeoff between portability and screen size and allowing objects everywhere to become smart by first becoming “dumb.”

In an embodiment, a wearable electronic computing hub device for wirelessly coupling with an electronic satellite device includes a wireless communication interface to wirelessly couple the hub device to the satellite device, at least one memory for storing processor-executable instructions and user data, and at least one processor communicatively coupled to the first wireless communication interface and the memory. Upon execution of the processor-executable instructions by the at least one processor, the at least one processor controls the wireless communication interface to wirelessly couple with the satellite device, which includes a touch screen, operate a graphical user interface for display on the touch screen, and receive at least one distinct signal from the satellite device. The at least one distinct signal is generated by the satellite device to represent at least one location of at least one touch that occurs in a plane of the touch screen. The at least one processor also processes the at least one distinct signal. Upon decoupling the hub device from the satellite device, the hub device stores at least some of the user data while the satellite device is incapable of retaining any of the user data, which includes the at least one distinct signal.

In an embodiment, a wearable electronic computing hub device for wirelessly coupling with an interchangeable electronic satellite device includes a wristband to be worn on the wrist of a user, a wireless communication interface to wirelessly couple the hub device to the satellite device, at least one memory for storing processor-executable instructions and user data, and at least one processor communicatively coupled to the first wireless communication interface and the memory. Upon execution of the processor-executable instructions by the at least one processor, the at least one processor controls the wireless communication interface to wirelessly couple with the satellite device based on a proximity of the satellite device, which includes a touch screen, operate a graphical user interface for display on the touch screen, and receive at least one distinct signal from the satellite device. The at least one distinct signal is generated by the satellite device to represent at least one location of at least one touch that occurs in a plane of the touch screen. The at least one processor also processes the at least one distinct signal. Upon decoupling the hub device from the satellite device, the hub device retains at least some of the user data while the satellite device is incapable of retaining any of the user data, which includes the at least one distinct signal.

In an embodiment, an electronic satellite device for wirelessly coupling with a wearable electronic computing hub device includes a wireless communication interface to wirelessly couple the satellite device to the hub device and a touch screen. Upon wirelessly coupling the satellite device with the hub device, the satellite device displays on the touch screen a graphical user interface operated, via the wireless communication interface, by the hub device, detects at least one touch that occurs in a plane of the touch screen, generates at least one distinct signal representative of at least one location of the at least one touch in the plane of the touch screen for each of the at least one touch, and transmits the at least one distinct signal to the hub device via the wireless communication interface, such that the hub device processes the at least one distinct signal. Upon decoupling the satellite device from the hub device, the hub device retains user data while the satellite device is incapable of retaining any of the user data, which includes the at least one distinct signal.

In an embodiment, a kit for personal computing includes a wearable electronic computing hub device and an electronic satellite device for wirelessly coupling with the hub device. In an embodiment, a method includes wirelessly coupling a wearable electronic computing hub device and at least one electronic satellite device. In an embodiment, a method includes wirelessly charging a wearable electronic computing hub device using at least one electronic satellite device through inductance charging and/or resonance charging.

In an embodiment, a hub computing apparatus to be worn as a personal accessory, the apparatus includes a housing having a shape to facilitate wearing by and/or contact with a person during operation of the apparatus, at least one sensor disposed within the housing to facilitate sensing of at least one motion of the apparatus, at least one communication interface disposed within the housing to facilitate wireless communication between the apparatus and at least one dumb display device, at least one battery disposed within the housing to provide power for the apparatus, at least one charging system disposed within the housing to wirelessly charge the at least one battery, at least one memory storing processor-executable instructions, and at least one processor, communicatively coupled to at least the at least one sensor, the at least one memory and the at least one communication interface. Upon execution by the at least one processor of the processor-executable instructions, the at least one processor A) monitors the at least one sensor to detect a first motion of the apparatus corresponding to a first gesture of the person, and B) controls the at least one communication interface to establish a first wireless communication link between the apparatus and the at least one dumb display device based at least in part on the first detected motion.

The shape of the housing may facilitate wearing of the apparatus around a wrist of the person. The first gesture of the person may include knocking by the person on the at least one dumb display device using a hand coupled to the wrist on which the apparatus is worn. The detected first motion may correspond to the knocking by the person.

In an embodiment, a system includes a hub computing apparatus and the at least one dumb display device wirelessly coupled to the hub computing apparatus. The at least one dumb display device may include a touch panel to facilitate user input and at least one second communication interface to facilitate wireless communication of video signals from the hub computing apparatus to the at least one dumb display device and at least one signal representing the user input from the at least one dumb display device to the hub computing apparatus. The system may further include a dongle to wirelessly receive video and audio signals from the hub computing device and transmit the received video and audio signals, via a high definition multimedia interface (HDMI), to a television or computer monitor.

In an embodiment, a kit includes the hub computing apparatus and the at least one dumb display device. The kit further may include a dongle to wirelessly receive video and audio signals from the hub computing device and transmit the received video and audio signals, via a high definition multimedia interface (HDMI), to a television or computer monitor.

In an embodiment, a hub computing apparatus to be worn as a personal accessory includes a housing having a shape to facilitate wearing by and/or contact with a person during operation of the apparatus, at least one communication interface disposed within the housing to facilitate wireless communication between the apparatus and at least one peripheral device, at least one battery disposed within the housing to provide power for the apparatus, at least one charging system disposed within the housing to wirelessly charge the at least one battery, at least one memory storing processor-executable instructions, and at least one processor, communicatively coupled to at least the at least one sensor, the at least one memory and the at least one communication interface. Upon execution by the at least one processor of the processor-executable instructions, the at least one processor controls the at least one communication interface to establish a first wireless communication link between the apparatus and the at least one peripheral device based at least in part on a proximity of the at least one peripheral device to the hub computing apparatus. The shape of the housing may facilitate wearing of the apparatus around a wrist of the person. The at least one peripheral device may include a touch panel to facilitate user input and at least one second communication interface to facilitate wireless communication of at least one signal representing the user input from the at least one peripheral device to the hub computing apparatus.

In an embodiment, a system includes the hub computing apparatus and the at least one peripheral device, the at least one peripheral device including a dongle to wirelessly receive video and audio signals from the hub computing device and transmit the received video and audio signals, via a high definition multimedia interface (HDMI), to a television or computer monitor.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

Other systems, processes, and features will become apparent to those skilled in the art upon examination of the following drawings and detailed description. It is intended that all such additional systems, processes, and features be included within this description, be within the scope of the present invention, and be protected by the accompanying claims.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates a wearable electronic hub device within a system in accordance with some embodiments.

FIG. 2 indicates locations for a wearable electronic hub device to be worn by a user under, with, or on top of clothing and accessories in accordance with some embodiments.

FIG. 3 is a block diagram of components included in a wearable electronic hub device in accordance with some embodiments.

FIGS. 4A, 4B, and 4C are front, side, and perspective views respectively of a wearable electronic hub device in accordance with some embodiments.

FIG. 5 is an assembly diagram of components for a wearable electronic hub device in accordance with some embodiments.

FIG. 6 illustrates a hardware based authentication process employing a wearable electronic hub device in accordance with some embodiments.

FIG. 7 illustrates various electronic satellite devices in accordance with some embodiments.

FIG. 8 is a block diagram for an electronic satellite device in accordance with some embodiments.

FIGS. 9A, 9B, and 9C are back, side, and front views respectively of a pocket-sized satellite device with enhanced communication mechanisms to interface with a wearable electronic hub device in accordance with some embodiments.

FIG. 10 is a perspective view of a tablet-sized satellite device with enhanced communication mechanisms to interface with a wearable electronic hub device in accordance with some embodiments.

FIG. 11A illustrates a wireless multimedia interface apparatus in accordance with some embodiments, and FIG. 11B is a block diagram of a wireless multimedia interface apparatus.

FIGS. 12A and 12B are perspective views of wireless multimedia interface apparatus in accordance with some embodiments.

FIG. 13 is a perspective view of a wearable electronic hub device and two pocket-sized dummy screen satellite devices in accordance with some embodiments.

FIG. 14 illustrates a kit in accordance with some embodiments.

FIG. 15 illustrates parallel output processes performed by a wearable electronic hub device in accordance with some embodiments.

FIG. 16 illustrates motion pairing or tethering of a wearable electronic hub device with an appliance in accordance with some embodiments.

FIG. 17 illustrates a wearable electronic hub device utilizing a satellite device with a touchscreen in accordance with some embodiments.

FIGS. 18A and 18B illustrates a method of initiating communication between a wearable electronic hub device and a satellite device using a gesture in accordance with some embodiments.

FIG. 19 illustrates a method for gesture-controlled device tethering in accordance with some embodiments.

FIGS. 20A and 20B illustrate gesture-based tethering of a wearable electronic hub device to a satellite device in accordance with some embodiments.

FIGS. 21A and 21B show screenshots from a user interface on a wearable electronic hub device or on a satellite device for tethering the devices and/or for confirming, adjusting, and/or changing communication mechanism settings with respect to a satellite device in accordance with some embodiments.

FIG. 22 illustrates a gesture tracking module in a wearable electronic hub device in accordance with some embodiments.

FIGS. 23A and 23B illustrate methods of implementing gesture-based controls in accordance with some embodiments.

FIG. 24A illustrates motion controlled device tethering between a wearable electronic hub device and multiple satellite devices in accordance with some embodiments, and FIG. 24B illustrates data manipulation on a second tethered satellite device by employing a first tethered satellite device and a hub device in accordance with some embodiments.

FIG. 25 illustrates induction charging between a wearable electronic hub device and a satellite device in accordance with some embodiments.

FIG. 26A illustrates a wearable electronic hub device configured for wireless charging in accordance with some embodiments, and FIG. 26B illustrate a logic flow for charging mode recognition in accordance with some embodiments.

FIG. 27 illustrates a method for wirelessly charging a wearable electronic hub device through magnetic resonance in accordance with some embodiments.

### DETAILED DESCRIPTION

The present disclosure describes systems, apparatus, and methods for personal computing, particularly relating to a wearable electronic hub device and an electronic satellite device for pairing with the wearable electronic hub device to enhance computing portability, versatility, efficiency, and security. According to some embodiments, the wearable electronic hub device removes the need for additional computing devices such as smartphones, tablet computers, laptop computers, etc., by comprising enough computing power to run most commonly used telecommunication and computing applications on interchangeable satellite devices with various display sizes. Thus, the hub device securely maintains the most important, expensive, and personal aspects of computing, whereas a satellite device can be shared, lost, stolen, and/or replaced without the same expense or risk to personal information associated with the duplicative hardware components and personal information in current computing devices.

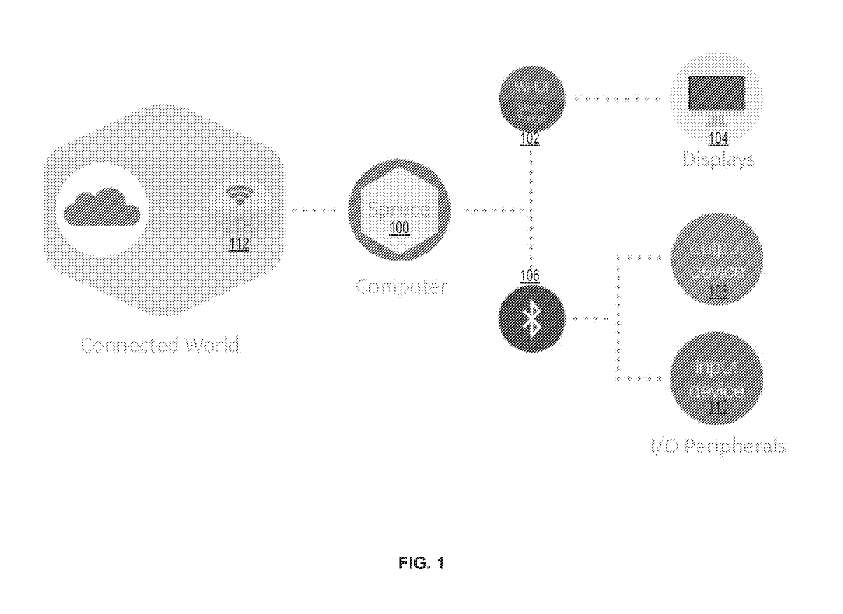

FIG. 1 illustrates a wearable electronic hub device within a system according to some embodiments. The electronic hub device 100 may be configured to use a first communication interface 102 (e.g., a Wireless Home Digital Interface (WHDI), available from Silicon Image (Hillsboro, Oreg.)) to deliver digital video from the hub device 100 over a wireless radio channel to any compatible display device 104. Alternatively or in addition, the electronic hub device 100 may be configured to use a second communication interface 106 (e.g., Bluetooth, available from SIG (Kirkland, Wash.)) to wirelessly exchange data over short distances using short-wavelength ultra-high frequency radio waves between the hub device 100 and any compatible peripheral output device 108 and/or input device 110. Alternatively or in addition, the electronic hub device 100 may be configured to use a third communication interface 112 to wirelessly exchange data over a telecommunication network (e.g., Long-Term Evolution (LTE), available from ETSI (Sophia Antipolis, France)).

### Wearable Electronic Hub Devices

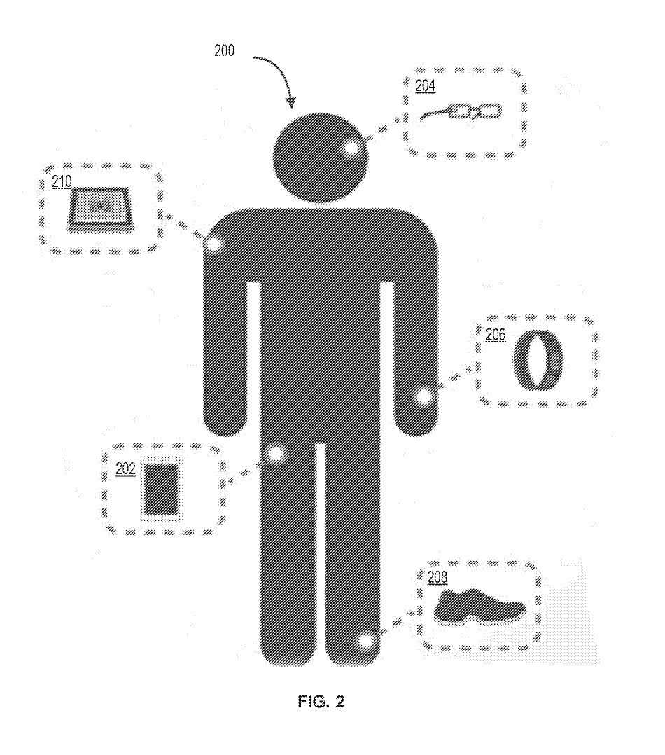

According to some embodiments, a wearable electronic hub device is a body-borne computer or wearable electronic hub device designed to be worn by a user under, with, or on top of clothing, accessories, or other wearable elements. FIG. 2 indicates potential locations on a user's body 200 to which to secure a hub device or wearable elements in which to embed a hub device according to some embodiments. For example, the hub device may be configured for securing to (e.g., clipping onto) or embedding in clothing 202. The hub device also may be configured for securing to or embedding in accessories like glasses 204, wristbands 206, and shoes 208. The hub device may even be configured for securing to or embedding in a user's skin (e.g., a patch including flexible electronics) 210. The placement of the hub device may depend on the intended application(s) and built-in sensors(s). Within various implementations, a wearable electronic hub device may appear in the form of a wrist band, a head band, a helmet, a neck tie, a pin, an arm band, a waist belt, foot wear, a badge, a key chain fob, and/or another wearable accessory.

According to some embodiments, a wearable electronic hub device includes at least one communication interface. The at least one communication interface may be configured to connect with another device using at least one of near-field communication, a contactless smart card, a wireless local area network (WLAN) (e.g., WiGig, WiFi, or other technologies that follow the IEEE 802.11 standard), a wireless personal area network (WPAN) (e.g., Bluetooth, ZigBee, or other technologies that follow the IEEE 802.15 standards), a cellular network (e.g., GSM, GPRS, CDMA, EV-DO, EDGE, UMTS, DECT, iDEN, HSPA, LTE, AMPS, PCS, or other technologies), a wireless wide area network (WWAN), a wireless mesh network, a wireless metropolitan area network (WMAN) (e.g., WiMAX or other technologies that follow the IEEE 802.16 standard), and a global navigation satellite system (GNSS) (e.g., the U.S. Global Positioning System (GPS), the E.U. Galileo positioning system, the Russian Global Navigation Satellite System (GLONASS), the Indian Regional Navigation Satellite System, the Chinese BeiDou Navigation Satellite System, or other systems). The hub device may include a wireless communication transceiver, disposed within a wearable electronic hub device body, to receive and transmit communications. The hub device may utilize a high-bandwidth wireless protocol (e.g., WiGig), along with Bluetooth Low Energy (Bluetooth LE) and/or Wi-Fi Direct, to stream video, audio, data, and other content.

According to some embodiments, a wearable electronic hub device includes at least one internal memory component with sizable storage.

According to some embodiments, a wearable electronic hub device includes a power supply interface, such as a power supply plug-in socket on the outer surface of the hub device for a power supply plug-in and/or at least one rechargeable battery, operably coupled to the at least one processor, to provide electrical power to the at least one processor. The hub device may also include a resonance charging coil (e.g., a coiled copper loop antenna), operably coupled to the power supply, to charge the power supply through magnetic resonance.

According to some embodiments, a wearable electronic hub device includes a data sensor to detect location movement and/or direction of the electronic hub device. The data sensor may include, but not limited to, one or more of an accelerometer (e.g., n-axis, where n can be 3, 6, or another positive integer), a gyrometer (e.g., n-axis, where n can be 3, 6, or another positive integer), and a digital compass.

According to some embodiments, a wearable electronic hub device includes at least one user interface, with one or more tactile (e.g., a button, a vibration motor), visual (e.g., a display, a touchscreen, a camera), and/or audio (e.g., a speaker, a microphone) input/output components. For example, a display or touchscreen may be only large enough for basic indications like one or more of time/date, a notification (e.g., a missed telephone call), and a connectivity toggle.

According to some embodiments, a wearable electronic hub device includes at least one processor. In some embodiments, a wearable electronic hub device includes a processor disposed within a wearable electronic hub device body and operably coupled to a wireless communication interface (e.g., a transceiver), an internal memory component, a battery, a data sensor, and/or an input/output component.

According to some embodiments, a wearable electronic hub device may determine a type of communication request and may generate a notification based on the communication type. The hub device may comprise a vibration motor, disposed within the device body to enable the device to vibrate. The vibration motor may comprise piezoelectric vibration mechanisms to facilitate various types of vibrations.

In some embodiments, the hub device may determine a vibration pattern based on the type of the communication request for the vibration motor to vibrate a wearable electronic hub device body according to the vibration pattern. A user may be able to customize said vibration patterns to, for example, distinguish incoming communications from different contacts. The configuration of customized vibration patterns may be enabled by a tangible haptic interface wherein the user may tap a configuration sequence on a wearable electronic hub device screen, wherein each tap on the configuration sequence is timely coordinated with a vibration pulse chosen from a pre-recorded set of unique vibration pulses available to configure customized vibration patterns.

In some embodiments, a wearable electronic hub device may determine that a movement detected by the motion sensor indicates a control command in response to a notification label and/or a vibration notification. In addition, a wearable electronic hub device may execute the determined control command.

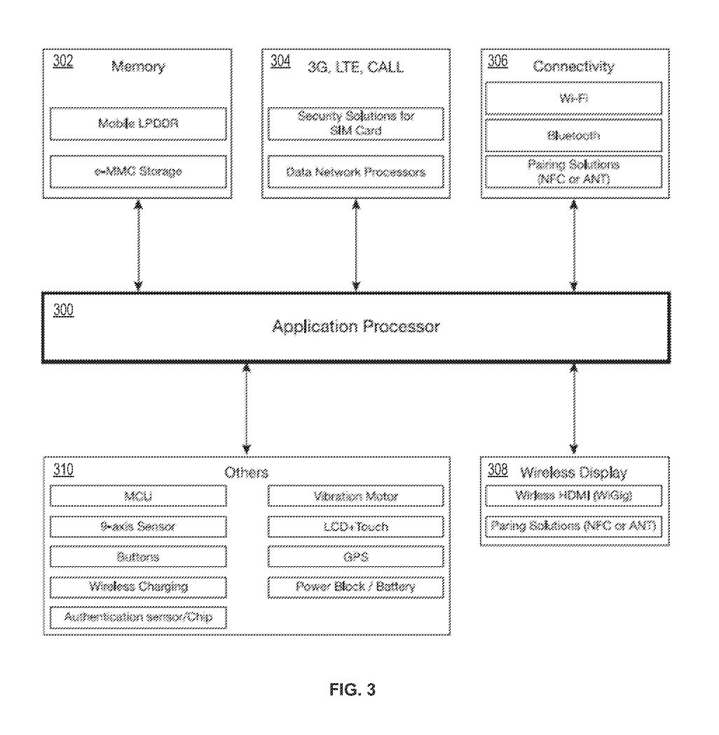

FIG. 3 illustrates a block diagram of components included in a wearable electronic hub device. In some embodiments, the device may comprise an application processor 300 (e.g. microprocessor) to enable a plurality of communications (e.g., telephone, text messages, email) as well as online and offline operations including, but not limited, to browsing the Internet, watching video streams, uploading and downloading files, writing text, and/or like applications. A wearable electronic hub device also comprises a memory module 302 including, for example, a low-power double data rate (LPDDR) random access memory capable to be connected over 16-bit or 32-bit memory bus per channel, an embedded multimedia controller (eMMC), and/or like components. A wearable electronic hub device may comprise a telecommunications module 304 (e.g., 3G, LTE) including security mechanisms for subscriber identity module (SIM) cards, a dedicated data network processor, and/or like components. In a further embodiment, a wearable electronic hub device may comprise a connectivity module 306, including mechanisms to enable wireless connectivity (e.g., Wi-Fi), mechanisms to establish short-range wireless interconnections (e.g., Bluetooth), pairing mechanisms to perform near field communications (NFC), multicast wireless sensor network technologies, etc.

A wearable electronic hub device may comprise a wireless display module 308, including a wireless high definition multimedia interface (e.g., WiGig), mechanisms to establish short-range wireless interconnections (e.g., Bluetooth), pairing mechanisms to perform near field communications (NFC), multicast wireless sensor network technologies, etc.

A wearable electronic hub device may further include one or more sensors, actuators, and other computing components 310 including, but not limited to, a multipoint control unit (MCU), a nine-axis motion tracking sensor with an embedded gyroscope, accelerometer, and/or compass, one or more buttons, wireless charging mechanisms, an authentication sensor and/or chip, a vibration motor, an LCD touch screen, a global positioning system (GPS), and a power block and/or battery.

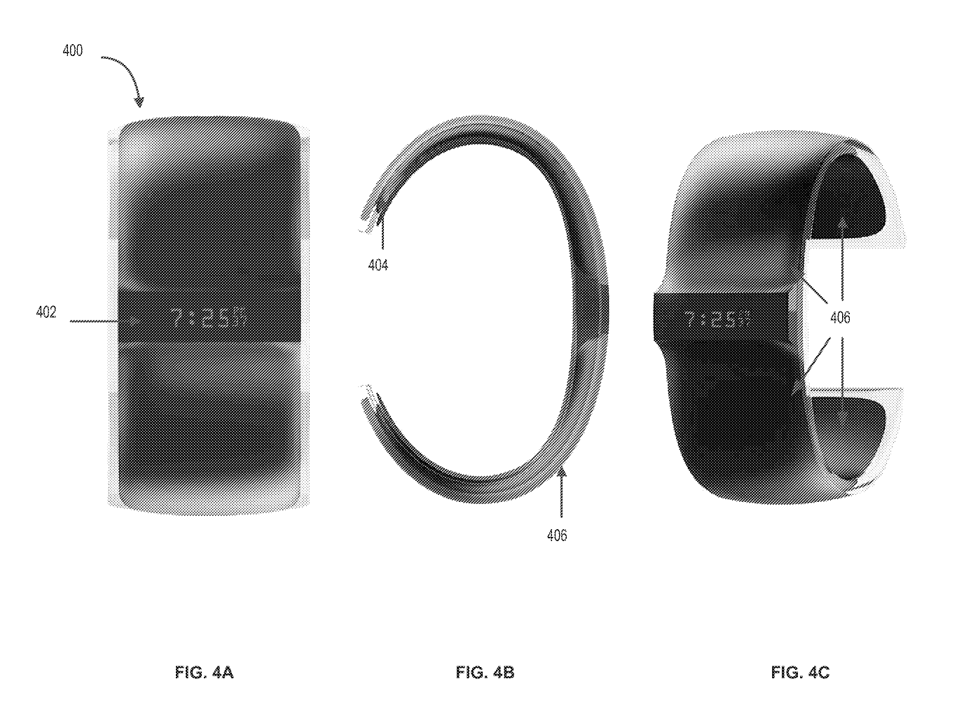

FIG. 4A is a front view of a wearable electronic hub device 400 according to some embodiments. The wearable hub device may comprise a wrist-band shaped body to be worn and removed from a wrist through a gap between two disjoint ends. The hub device may comprise a digital display 402, visible via an outer surface of the wrist-band shaped body, to display a time/date, connectivity toggles, and notifications such as incoming emails, incoming text messages, event alerts, and/or the like. In a further embodiment, the digital display may comprise tactile capabilities such as control through simple or multi-touch gestures, compatibility with touch screen stylus pens and/or the like. Furthermore, a wearable electronic hub device may comprise a button to perform a hard reset on the system.

FIGS. 4B and 4C are side view and perspective views respectively of the hub device in FIG. 4A. The hub device may have a protective shell made of transparent and flexible nylon that encapsulates a blackpainted printed circuit board made of one or more flexible materials (e.g., a polyimide core, overlay, and/or the like) combined with multilayers of a rigid material (e.g., FR4 IPC-4101/21, high-Tg FR4 filled, and/or the like) to provide a built-in connection and/or to make a three-dimensional wrist-band shaped form comprising the circuit components. In some embodiments, transparency may be used to create the illusion/perception of smaller size. In some embodiments, a wearable electronic hub device may comprise one or more polycarbonate plastic layers 404 and/or solid type nylon layers 406 to protect the internal components of the hub device. The solid type nylon layer makes the hub device waterproof and/or water resistant.

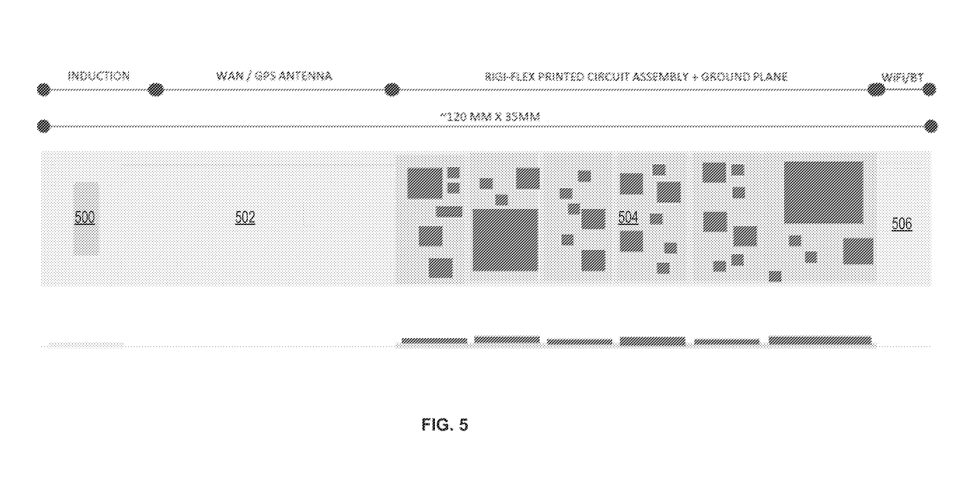

FIG. 5 is an assembly diagram for a wearable electronic hub device in accordance with some embodiments. The hub device may be a wristband including, along its length, an induction region 500, an antenna region 502, a circuit assembly region 504, and a communication interface component region 506 (e.g., WiFi, Bluetooth, etc.).

### Authentication Methods

According to some embodiments, security for a wearable electronic hub device relies on a user performing an authentication method, either actively (e.g., the user enters a password or submits to biometric scanning) or passively (e.g., the device automatically recognizes a biometric signal, such as a heart signature). A user's biometric data may include, but is not limited to, a fingerprint, an iris/retina scan, a heart-signature, a blood pressure pattern, a body temperature pattern, etc. In some embodiments, a wearable electronic hub device includes one or more sensors for collecting biometric data.

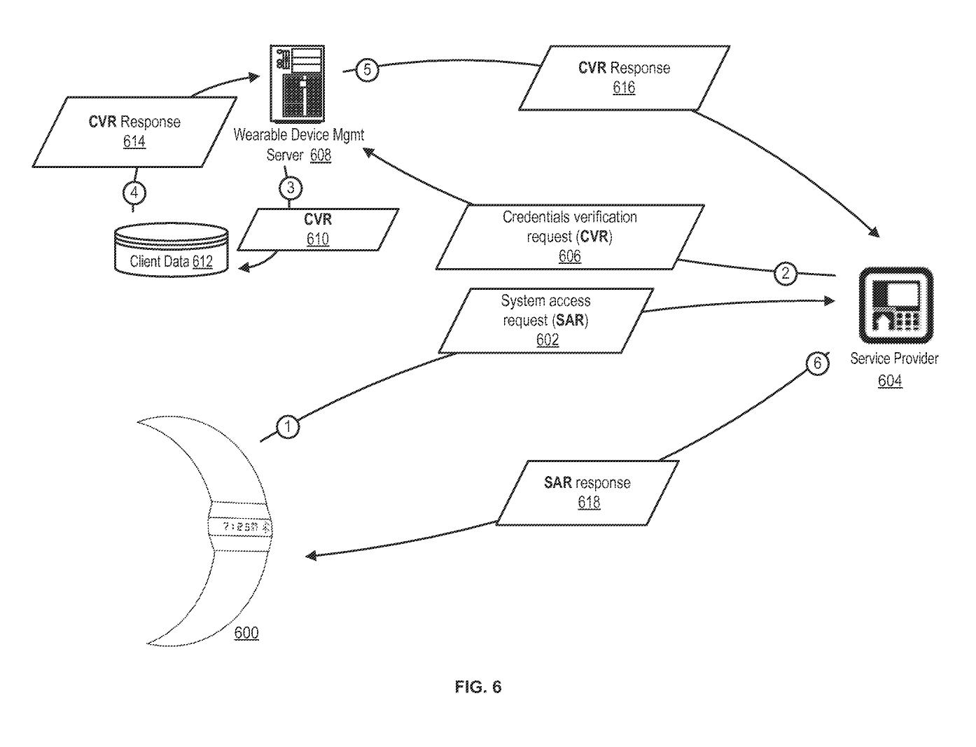

FIG. 6 illustrates a hardware based authentication process employing a wearable electronic hub device according to some embodiments. The hub device 600 with a hardware identifier may send a system access request (SAR) 602 to a user service provider 604 (e.g., an online banking system that requires user credentials to login). The SAR 602 may include a set of user credentials. User credentials may include, but not limited to, one or more of the hardware identifier, IP address, physical address, GPS location, biometric data, etc. The user service provider 604 may extract one or more of the user credentials from the SAR 602. The user service provider 604 may then send a credentials verification request (CVR) 606, including one or more of the extracted credentials, to a management server 608 to verify/authenticate the hub device 600.

In some embodiments, the management server 608 forwards a corresponding CVR 610 to a repository of client data 612 or otherwise accesses the repository 612. The data repository 612 may store client credentials to verify the validity of the user credentials received with the CVR 606, 610. Thereafter, the management server 608 may receive from the data repository 612 a response to the CVR 614 and may send a corresponding CVR response 616 to the service provider 604 to confirm whether the user credentials received with the CVR 606, 610 are associated with an existing client of the service provider 604. The service provider 604 may analyze the CVR response 616 and/or send a corresponding SAR response 618 to the hub device 600.

For example, when a user uses the hub device 600 to access a service provider 604, the provider 604 may detect the source of the access request as originating from a wearable electronic hub device, and may provide an option of, for example, “Login with Your Wearable Device.” Upon user selection of this login mode, the service provider 604 may collect the hardware identifier of the hub device 600 and additional information. The service provider 604 may direct the SAR 602 to the management server 608, which may in turn authenticate the hub device 600 based on a database 612 of hardware identifiers. In this way, the user wearing the hub device 600 may not need to enter additional credentials (e.g., user name, password, etc.) to securely login into a personal account with the service provider 604.

### Dummy Screen Devices and Other Electronic Satellite Devices

A “dumb” or “dummy” device may have basic connectivity (e.g., WiGig, Bluetooth LE, or WiFi Direct) in order to pair or tether with a wearable electronic hub device. A dummy device may physically resemble a smart device like a typical smartphone or tablet computer because it includes a display screen and/or a speaker to output what the hub device serves wirelessly as well as a capacitive touch panel, a microphone, a camera, and/or a sensor to transmit audio, video, and/or sensory input back to the hub device. A dummy device may even wirelessly charge the hub device. What a dummy device does not do is keep data received from or transmitted to the hub device, particularly after a pairing or tethering session has ended.

According to some embodiments, a dummy device is an example of an electronic satellite device that can be shared, lost, stolen, and/or replaced without the same security risks and expenses associated with the duplicative hardware components and personal information in current smartphones, tablet computers, laptop computers, and other devices. A user does not need to sync a satellite device to download personal information from another device or server because the user always has the necessary personal information to operate the satellite device conveniently stored on the same wearable electronic hub device. Satellite devices may be agnostic as to the operating system of the hub device. In some embodiments, a user may start an application on one satellite device screen then seamlessly transition to another satellite device screen without closing the application, taking the time to sync information, or losing information.

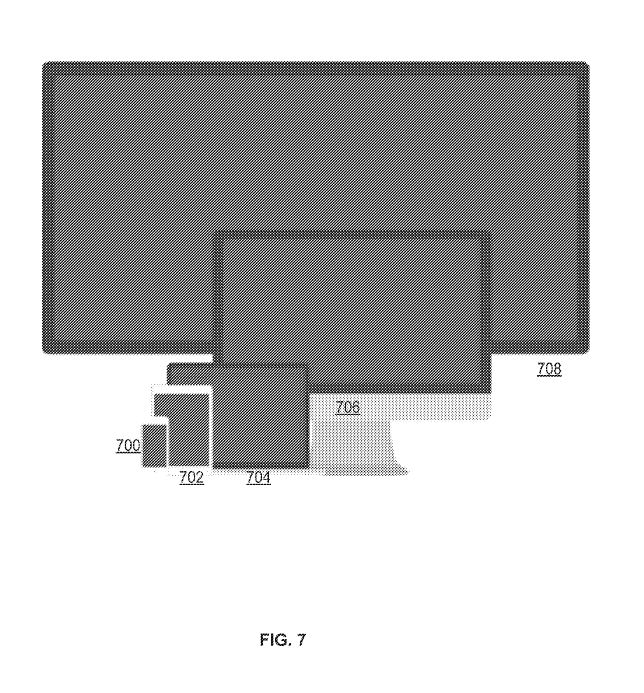

Because the wearable hub device retains all the necessary personal computing information, a satellite device does not need to retain any personal data and has smaller memory and/or energy requirements. As a result, satellite devices may be lighter, thinner, less expensive, easier to design and manufacture, and/or easier to aggregate and/or integrate with different environments. For example, one or more satellite devices may be kept in a user's home, office, car, etc., so that the user only needs to carry a wearable electronic hub device and nothing more. Such a satellite device may resemble, as shown in FIG. 7, a pocket-sized smartphone 700, a tablet computer 702, a laptop computer 704, a desktop computer 706, or a television 708. A satellite device may also be a wireless keyboard, mouse, headphone set, dongle, or other input/output device.

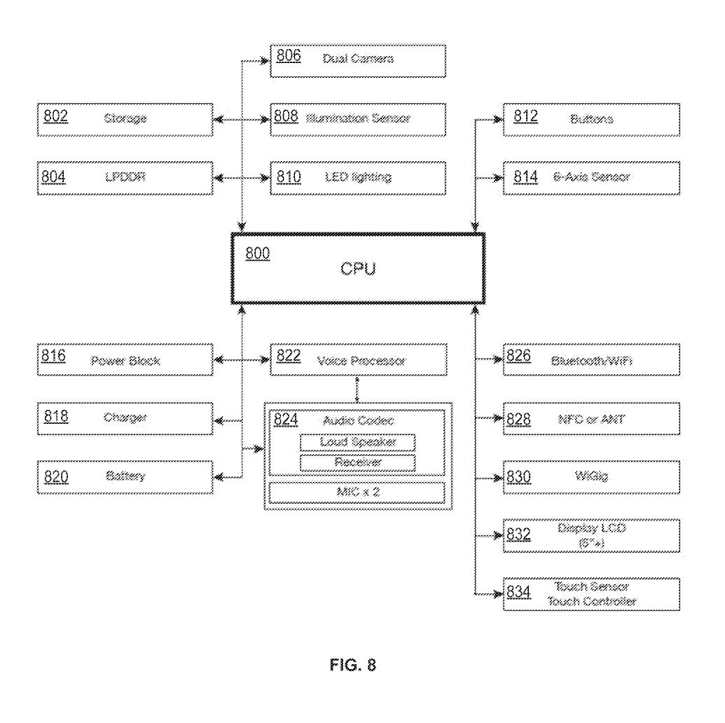

FIG. 8 is a block diagram for an electronic satellite device according to some embodiments. A satellite device may include a central processing unit (CPU) 800 for controlling and executing operations over a plurality of resources and components including, but not limited to, one or more of some storage 802, random access memory 804 (e.g., LPDDR), a camera 806 (e.g., dual front and rear facing), an illumination sensor 808, lighting 810 (e.g., LED), a button 812, an n-axis sensor 814 (where n can be 3, 6, or another positive integer), a power block 816, a charging component/mechanism 818 (e.g., wireless), a battery 820 (e.g., high capacity), a voice processor 822, an audio codec mechanism 824 (e.g., a receiver, microphone, an in-ear speaker, a loudspeaker, a 3.5 mm audio and microphone jack), a communication interface component/mechanism (e.g., Bluetooth/WiFi 826, NFC or ANT 828, and WiGig 830), a display 832 (e.g., LCD), and a touch sensor/controller/input device 834 (e.g., a touch panel).

According to some embodiments, an electronic satellite device includes at least one communication interface. The at least one communication interface may be configured to connect with a wearable electronic hub device using at least one of near-field communication, a contactless smart card, a wireless local area network (WLAN) (e.g., WiGig, WiFi, or other technologies that follow the IEEE 802.11 standard), a wireless personal area network (WPAN) (e.g., Bluetooth, ZigBee, or other technologies that follow the IEEE 802.15 standards), and a global navigation satellite system (GNSS) (e.g., the U.S. Global Positioning System (GPS), the E.U. Galileo positioning system, the Russian Global Navigation Satellite System (GLONASS), the Indian Regional Navigation Satellite System, the Chinese BeiDou Navigation Satellite System, or other systems). The satellite device may include a wireless communication transceiver, disposed within the satellite device body, to receive and transmit communications from a hub device. The satellite device may utilize a high-bandwidth wireless protocol (e.g., WiGig), along with Bluetooth Low Energy (Bluetooth LE) and/or Wi-Fi Direct, to stream video, audio, data, and other content from a hub device.

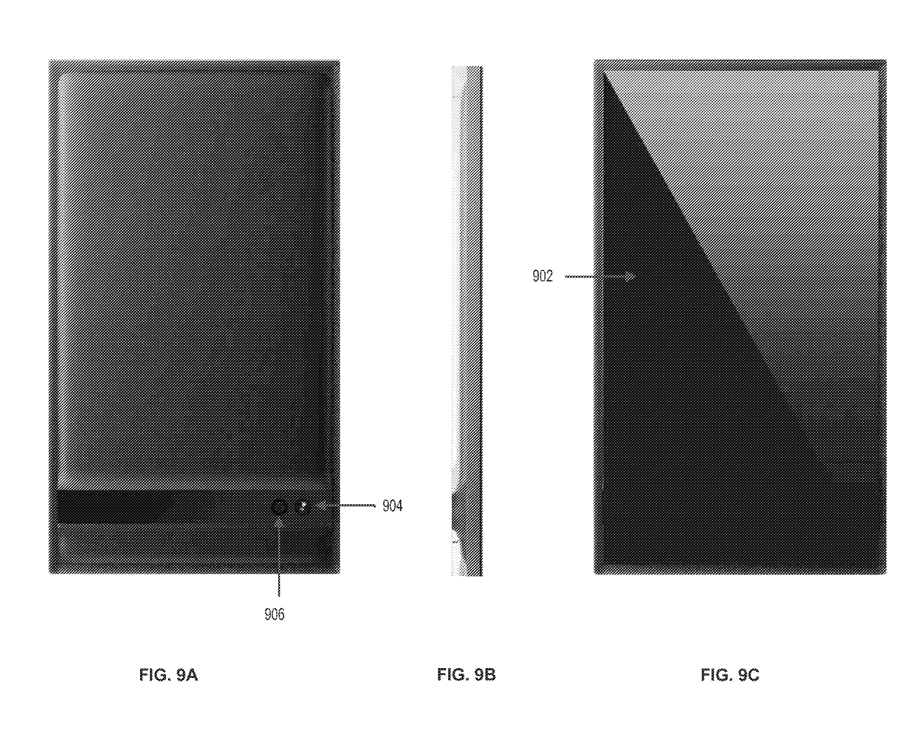

FIGS. 9A, 9B, and 9C are back, side, and front views respectively of a pocket-sized satellite device with enhanced communication mechanisms to interface with a wearable electronic hub device according to some embodiments. The satellite device may be, for example, the size of a typical smart phone. The satellite device may include a high pixel density screen (e.g., 320 ppi), enhanced with a capacitive touch panel 902 (i.e., a touch screen). Additionally, a satellite device may include a flash 904 (e.g., dual LED) and/or a camera 906 (e.g., front-facing and/or rear-facing). Further embodiments of a satellite device include one or more additional components including, but not limited to, a transceiver for audio and/or video streaming, a wireless connectivity component (e.g., Bluetooth LE), an embedded microphone, an in-ear speaker, a loudspeaker, a proximity sensor, an accelerometer, a gyroscope, a battery (e.g., high capacity), and a wireless charging component (i.e., to support wireless charging of a wearable electronic hub device).

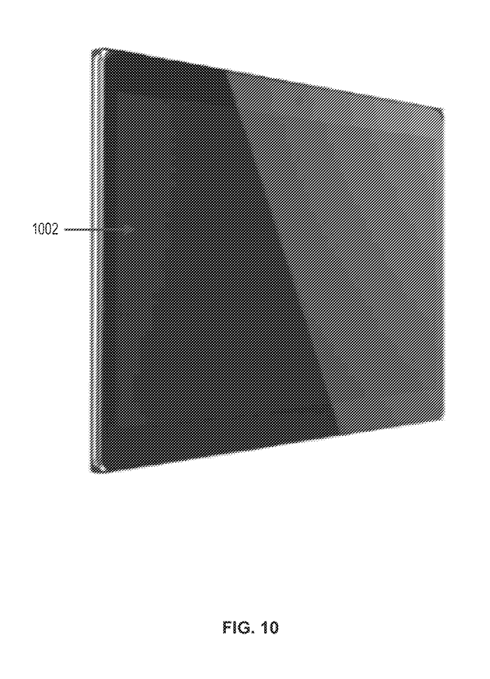

FIG. 10 is a perspective view of a tablet-sized satellite device with enhanced communication mechanisms to interface with a wearable electronic hub device according to some embodiments. The satellite device may include a capacitive touch screen 1002 (i.e., a touch screen). Further embodiments of the satellite device may include one or more additional components including, but not limited to, a flash, a camera, a transceiver for audio and/or video streaming, a wireless connectivity component (e.g., Bluetooth LE), an embedded microphone, an in-ear speaker, a loudspeaker, a proximity sensor, an accelerometer, a gyroscope, a battery (e.g., high capacity), and a wireless charging component (i.e., to support wireless charging of a wearable electronic hub device).

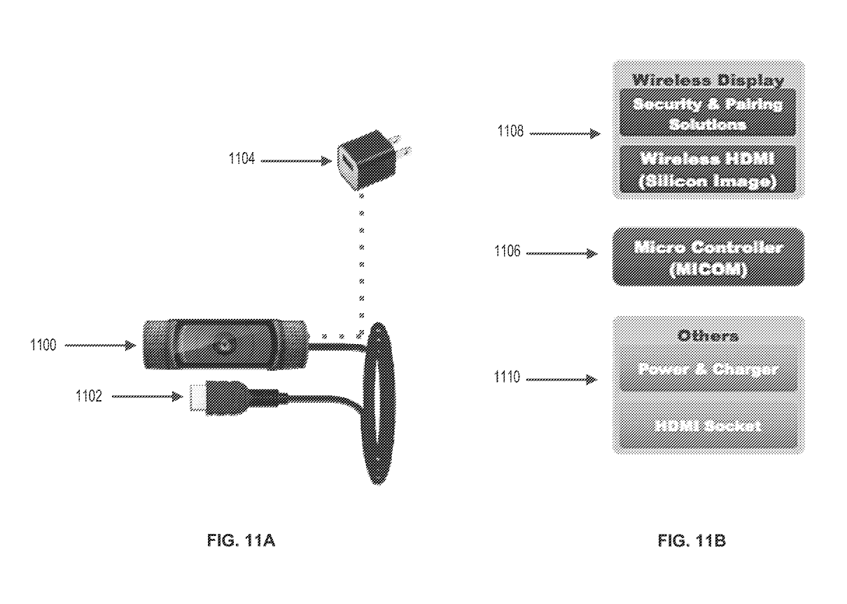

FIG. 11A illustrates a wireless multimedia interface apparatus 1100 according to some embodiments. A wearable electronic hub device may be wirelessly connected to a wireless multimedia interface apparatus 1100. The multimedia interface apparatus 1100 may include a wireless transceiver coupled to and/or embedded within the multimedia interface apparatus 1100 to receive data content via a wireless connection to the hub device. The multimedia interface apparatus 1100 further may include a multimedia data format converter, coupled to and/or embedded within the multimedia interface apparatus 1100 and communicatively coupled to the wireless transceiver, to convert a data format of the data content to a multimedia format compatible for display at a satellite device (e.g., on a television screen). In addition, the multimedia interface apparatus 1100 may include a multimedia interface connector 1102 (e.g., HDMI connector), communicatively coupled to the multimedia data format converter, to be plugged into a multimedia input receptacle of the satellite device (e.g., a television, projector, desktop computer monitor, etc.) to transmit the data content in the multimedia format to the satellite device for display. In some embodiments, the multimedia interface apparatus 1100 may include a power adapter 1104 for the satellite device.

FIG. 11B is a block diagram of a wireless multimedia interface apparatus according to some embodiments. The multimedia interface apparatus may comprise a microcontroller 1106 (MICOM), a wireless display module 1108 including, for example, security and pairing mechanisms and a multimedia interface connector (e.g., a wireless HDMI mechanism), and other components 1110 including, but not limited to, battery and/or charger, HDMI socket, etc.

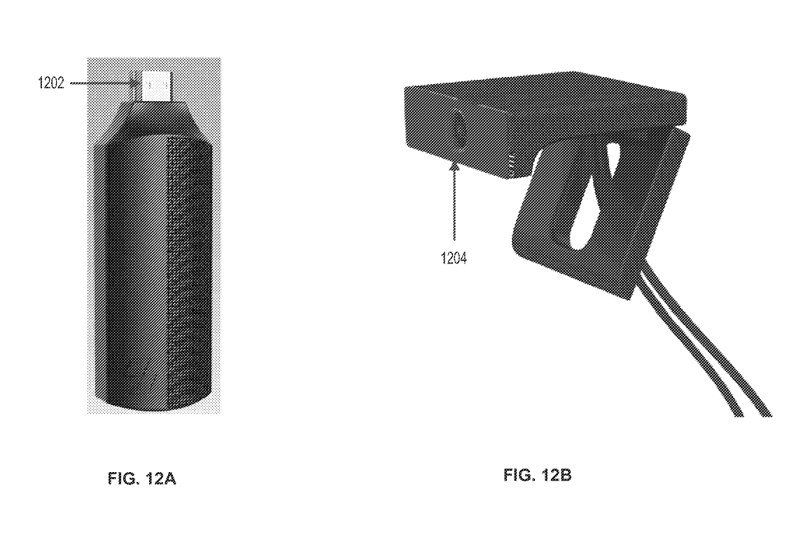

FIGS. 12A and 12B are perspective views of wireless multimedia interface apparatus according to two embodiments. In FIG. 12A, a wireless multimedia interface apparatus is a dongle with a multimedia interface connector 1202 (e.g., HDMI connector) for coupling with a satellite device (e.g., plugging into a multimedia input receptacle of a television, projector, desktop computer monitor, etc.) and displaying video and/or audio output received from a wearable electronic hub device. In FIG. 12B, a wireless multimedia interface apparatus includes a camera 1204 for transmitting video input back to a wearable electronic hub device.

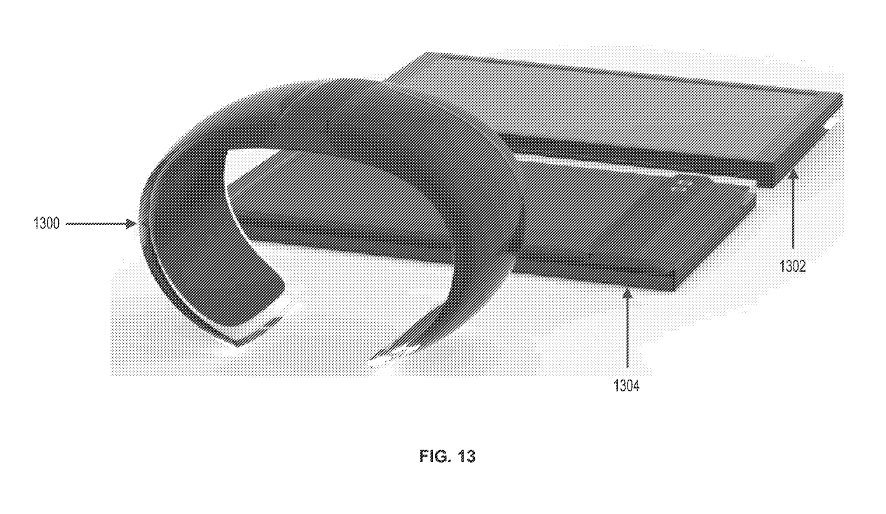

FIG. 13 is a perspective view of a wearable electronic hub device 1300 and two pocket-sized dummy screen satellite devices 1302, 1304 according to some embodiments. The hub device may be provided as part of a kit with one or more satellite devices. For example, a user may want more than one pocket-sized dummy screen satellite device so as to be able to use one while the other is charging and/or to have them in available in different environments (e.g., home and work).

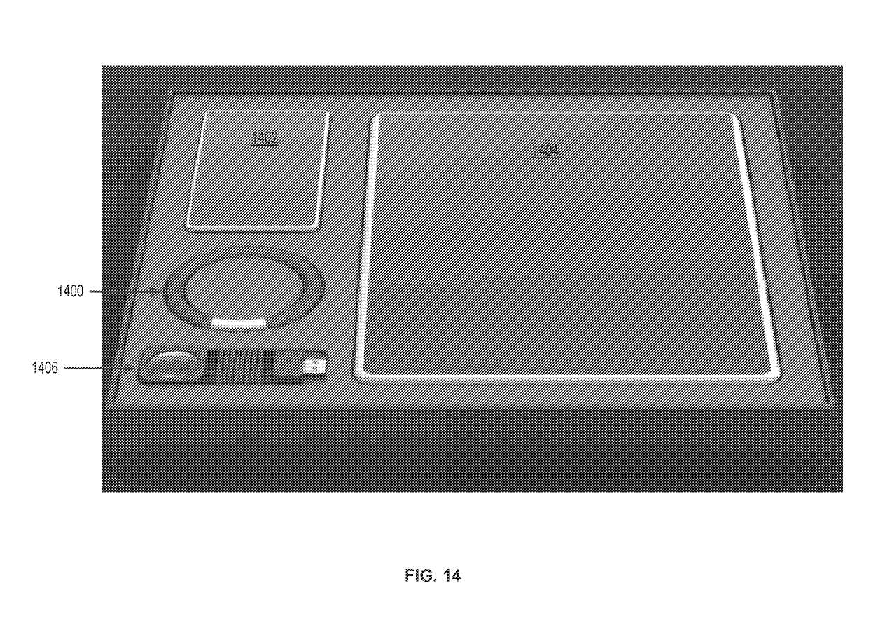

FIG. 14 illustrates a kit according to some embodiments. The kit may include, but is not limited to, a wearable electronic hub device 1400, a pocket-sized dummy screen satellite device 1402, a tablet-sized dummy screen satellite device 1404, and a charging apparatus 1406 for charging at least one of the hub device 1400 and the dummy screen satellite devices 1402, 1404.

### Wireless Recognition and Pairing/Tethering

Instead of trying to maximize screen size on a wearable electronic hub device carrying the most important, expensive, and personal aspects of computing, wearable smart devices may be paired with interchangeable satellite devices, such as dummy screen devices The satellite device may have basic connectivity (e.g., WiGig, Bluetooth LE, and/or Wi-Fi Direct) to wirelessly connect with a hub device, display output from the hub device, and transmit user input back to the hub device.

In some embodiments, a wearable electronic hub device and a satellite device comprise low power consumption wireless communication mechanisms, such as Bluetooth LE. Bluetooth LE provides a lightweight link layer capable of providing ultra-low power idle mode operation, simple device discovery, and reliable point-to-multipoint data transfer with advanced power-save and secure encrypted connections. A device may remain in sleep mode most of the time, only waking up when it receives a connection request through the Bluetooth LE mechanism, thus keeping power consumption to a minimum.

A wearable electronic hub device may send, via a wireless transceiver, a connection request to a satellite device. Thereafter, the hub device may receive, via the wireless transceiver, a connection approval from the satellite device in response to the connection request. Now paired or tethered to the satellite device, the hub device then may send, via the wireless transceiver, data content to output (e.g., display) on the satellite device and receive, via the wireless transceiver, data content input collected by the satellite device. Alternatively, a wearable electronic hub device may receive, via a wireless transceiver, a connection request from a satellite device. Thereafter, the hub device may send, via the wireless transceiver, a connection approval to the satellite device in response to the connection request. Now paired or tethered to the satellite device, the hub device then may send and receive, via the wireless transceiver, data content.

In some embodiments, a wearable electronic hub device automatically pairs or tethers to a satellite device based at least on the proximity of the satellite device and/or satellite device recognition.

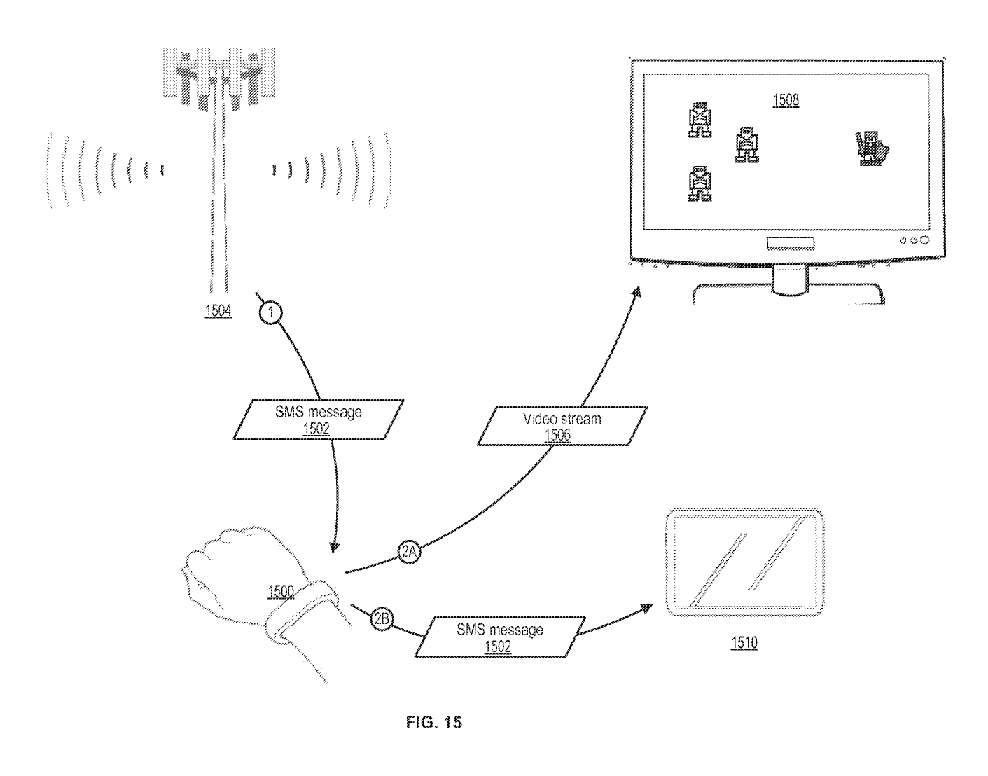

A wearable electronic hub device may recognize and be paired or tethered with only one satellite device, one satellite device at a time, or more than one satellite device, concurrently or in sequence. FIG. 15 illustrates parallel output processes performed by a wearable electronic hub device according to some embodiments. A wearable electronic hub device 1500 may receive a SMS message 1502 from a mobile phone tower 1504. Thereafter, the hub device 1500 may concurrently start or alternatively continue a video streaming process 1506 with a first satellite device 1508 while sending the SMS message 1502 to be displayed on a second satellite device 1510.

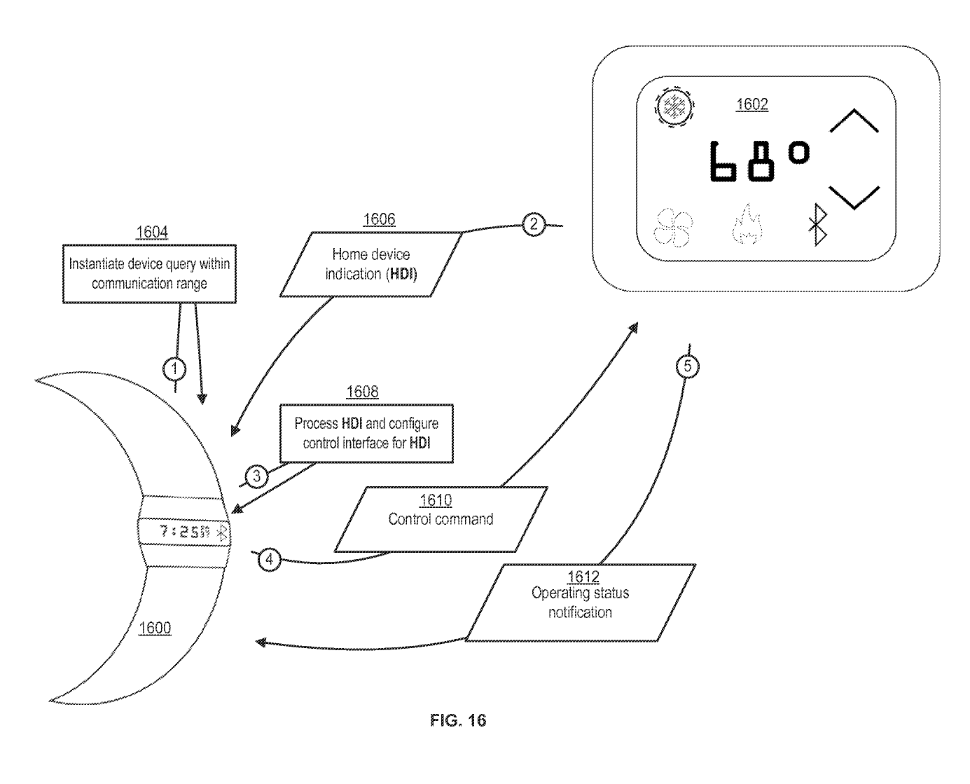

FIG. 16 illustrates motion pairing or tethering of a wearable electronic hub device 1600 with an appliance 1602 according to some embodiments. In step 1604, the hub device 1600 instantiates a device query on a communication stack within a communication range of the hub device 1600 comprising a wireless transceiver operably coupled to a processor. For example, the communication stack may be established by the hub device 1600 via a variety of local communication protocols such as but not limited to Wi-Fi, Bluetooth, Bluetooth LE, NFC, iBeacon, etc. In step 1606, the hub device 1600 receives, via the wireless transceiver, an indication of an electronic satellite device 1602 (e.g., a home device indication (HDI) for a domestic appliance, such as a microwave, a refrigerator, a laundry machine, a thermostat, etc.) in the communication stack (based at least in part on a proximity/communication range). In step 1608, the hub device 1600 processes the indication (e.g., HDI) and configures the control interface accordingly. The hub device 1600 may extract a device identifier for the satellite device 1602 from the received indication (e.g., HDI), query a list of pre-stored device identifiers for a match to the extracted device identifier to determine a type of the satellite device 1602, and configure a control interface based on the type of the satellite device 1602. In step 1610, the hub device 1600 sends a control command based on the configured control interface to the satellite device 1602. In step 1612, the hub device 1600 receives, from the satellite device 1602, a notification indicative of the operating status of the satellite device 1602 in response to the control command. In some embodiments, a domestic or commercial electronic device manufacturer may be provided with a hardware development kit (HDK) to equip home electronic devices with hardware components to interface with a wearable electronic hub device control commands.

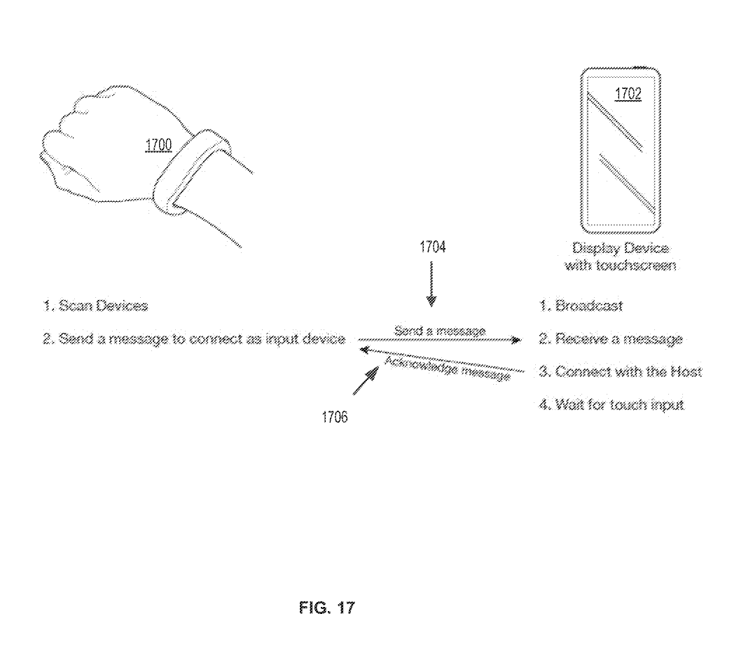

FIG. 17 illustrates a wearable electronic hub device 1700 utilizing a satellite device with a touchscreen 1702 according to some embodiments. The hub device 1700 scans for satellite devices within a predetermined proximity area. The satellite device with touchscreen 1702 may broadcast a message to be found by the hub device. Alternatively, or in addition, the hub device 1700 may send a message 1704 specifically to connect as an input device to the satellite device with touchscreen 1702. The satellite device with touchscreen 1702 may receive the message and may respond to it with an acknowledgement message 1706. Thereafter, the hub device 1700 may automatically pair or tether with the satellite device with touchscreen 1702. Alternatively, the satellite device may not be paired or tethered until a touch input or other command is performed by a user wearing the hub device 1700.

In some embodiments, a user of a wearable electronic hub device may access a screen to confirm, adjust, and/or change settings of a particular communication mechanism and/or to view the devices that are tethered through a particular communication mechanism. In addition, a user may enable or disable a communication mechanism (e.g., Bluetooth LE) using, for example, a toggle control. Similarly, a user may enable or disable an auto-connect mode employing, for example, another toggle control. When an auto-connect setting is enabled, a wearable electronic hub device may automatically connect to one or more known devices within a proximity of the hub device. Moreover, a user of a wearable electronic hub device may view the satellite device(s) to which a wearable electronic hub device is tethered. For example, a wearable electronic hub device may be simultaneously wirelessly tethered via Bluetooth LE to a pocket-sized dummy screen device and also to a wireless multimedia interface apparatus for streaming to a television.

### Motion Patterns and Gesture-Based Controls

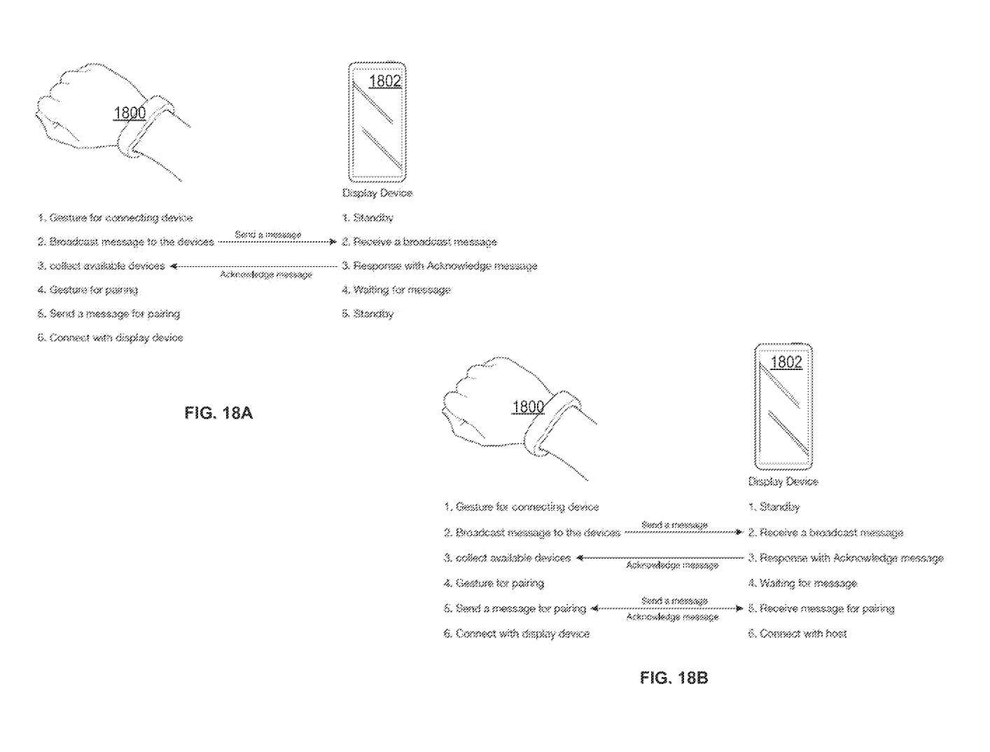

FIGS. 18A and 18B illustrates a method of initiating communication between a wearable electronic hub device 1800 and a satellite device 1802 using a gesture according to some embodiments. In FIG. 18A, a user performs a first gesture with the hub device 1800 to indicate a desire to connect the hub device 1800 with the satellite device 1802. The gesture may resemble, for example, a knocking (e.g., a motion similar to knocking on a door) or waving motion, directed to either one or both of the hub device 1800 and the satellite device 1802. The pattern of the motion is recognized by a sensor coupled to and/or embedded in at least one of the hub device 1800 and the satellite device 1802. The hub device 1800 may send a message comprising connection information and/or a connection request to the satellite device 1802 (or all satellite devices within a predefined proximity area). If the satellite device 1802 receives the message, it may respond to hub device 1800 with an acknowledgment message comprising relevant information to establish a connection such that the hub device 1800 and the satellite device 1802 may establish a connection for communication. The satellite device 1802 then waits in a standby mode. In FIG. 18B, a user performs a second gesture with the hub device 1800 to indicate a desire to communicatively pair or tether the hub device 1800 to the satellite device 1802. The hub device 1800 may send a message comprising pairing information and/or a pairing request to the satellite device 1802. If the satellite device 1802 receives the message, it may respond to hub device 1800 with an acknowledgment message comprising relevant information to establish pairing or tethering.

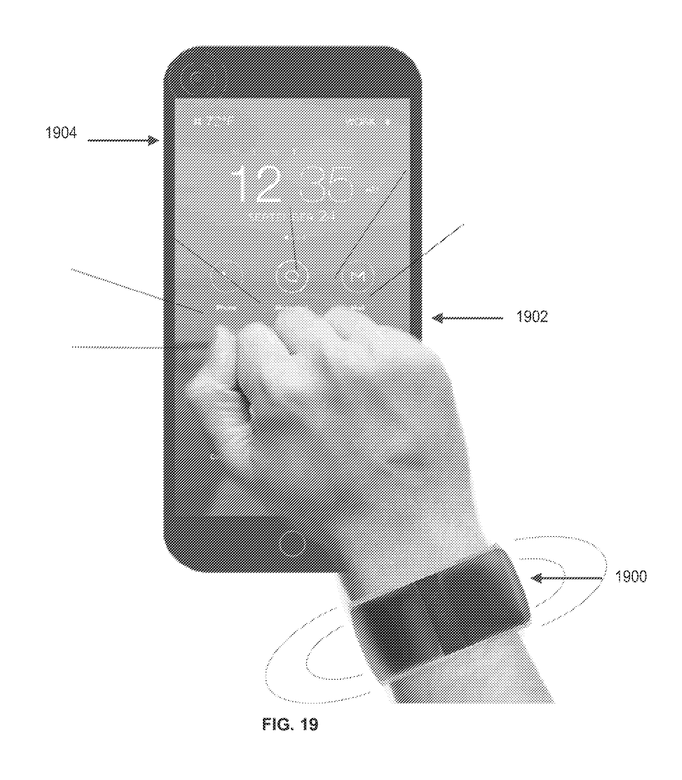

FIG. 19 further illustrates a method for gesture-controlled device tethering according to some embodiments. A motion sensor disposed within the body of a wearable electronic hub device 1900 may sense, recognize, and indicate to the hub device a motion pattern 1902 corresponding to, for example, knocking on a satellite device 1904. The satellite device 1904 may include any user interface output device, including a display screen, audio speaker, etc. The hub device may determine whether the motion pattern indicates a request to tether the hub device to a satellite device. The hub device further may instantiate a device query on a communication stack within communication range of the hub device in response to the tethering request. For example, a motion pattern like “knock-knock” (e.g., when the user wearing the hub device double-knocks at a surface) may indicate a tethering request within the communication stack to an output device.

In some embodiments, a motion pattern like “knock-knock” or another motion pattern instead may indicate a tethering request when a communication request is received at a wearable electronic hub device. For example, a user wearing the hub device around his or her wrist may receive a phone call at the hub device (notified by, e.g., a beep, vibration, etc.). The user may raise the device by raising his or her wrist to scratch behind his or her ear, and thereby trigger a command for a wearable electronic hub device to answer the phone call, etc. A variety of different motion patterns may be used for motion control of the hub device including, but not limited to, waving, scratching, knocking, and tapping (one or more fingers). In one implementation, a user may define a motion pattern for a designated command via a user interface component, for example, defining “knock-knock” as a tethering request for nearby display device, “scratching” as answering an incoming call, “waving” as moving the mouse on a tethered display device, etc.

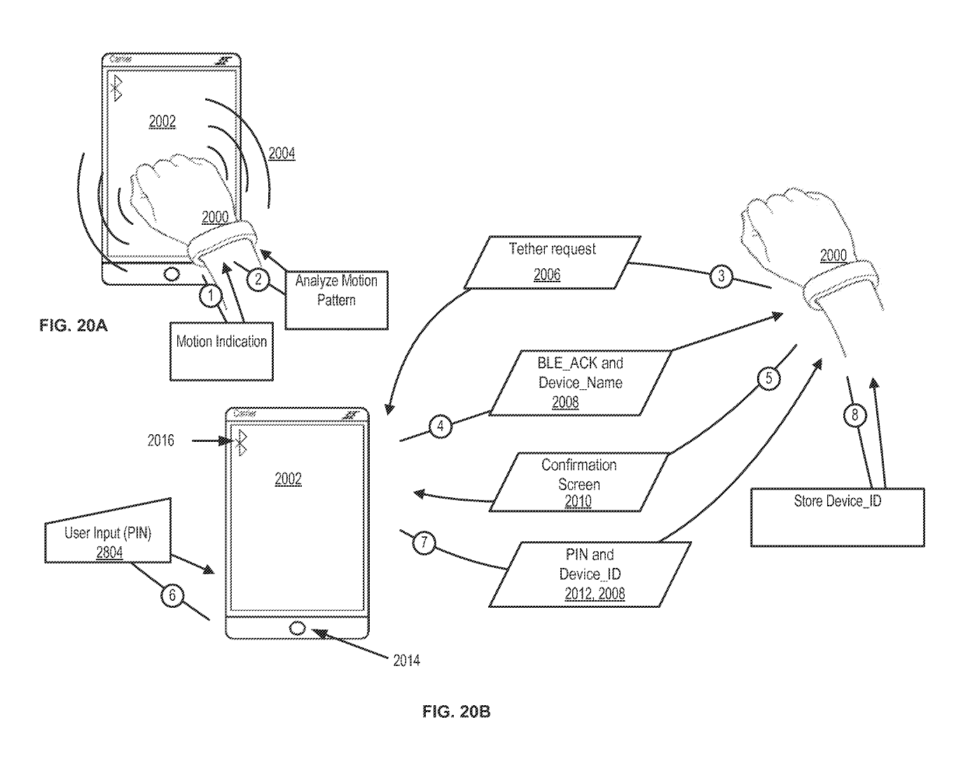

FIG. 20A illustrates a gesture indicating a first time tethering a wearable electronic hub device 2000 to a satellite device 2002 according to some embodiments. A user wearing a hub device 2000 may perform a motion pattern 2004 within a predetermined proximity of a satellite device 2002. The motion pattern 2004 may be, for example, moving the hub device 2000 horizontally from left to right or vertically up and down, etc. The hub device 2000 may recognize that a motion pattern has been performed and subsequently may analyze the motion pattern to determine whether the motion pattern 2004 matches a preprogrammed motion pattern to command a wireless tethering request. If so, as shown in FIG. 20B, the hub device 2000 may send a tethering request 2006 to the satellite device 2002. Furthermore, the satellite device 2002 may send an acknowledgement message comprising a device identification number or name 2008 to the hub device 2000. The acknowledgement message may only be sent after the satellite device 2002 has received the tethering request 2006. In a further embodiment, the hub device 2000 may send a command to display a confirmation screen 2010 to the satellite device 2002. Additionally, the satellite device 2002 may display the confirmation screen to be viewed by the user of the hub device 2000.

In some embodiments, as shown in FIG. 20B, the user with the wearable electronic hub device 2000 inputs a personal identification number (PIN) 2012 using a user interface of the satellite device 2002. The PIN 2012 and a device ID 2008 may be sent from the satellite device 2002 to the hub device 2000. The hub device 2000 may store the device identification number 2008 in a local repository for future automatic recognition and/or tethering. In a further embodiment, every time the user wakens the satellite device 2002 by, for example, pressing button 2014, the satellite device 2002 may remain wirelessly tethered to the hub device 2000 (e.g., via Bluetooth LE as indicated by the symbol 2016). Furthermore, a user may press and hold button 2014 for few seconds to untether the hub device 2000 from the satellite device 2002 such that the satellite device 2002 can be tethered with another wearable electronic hub device.

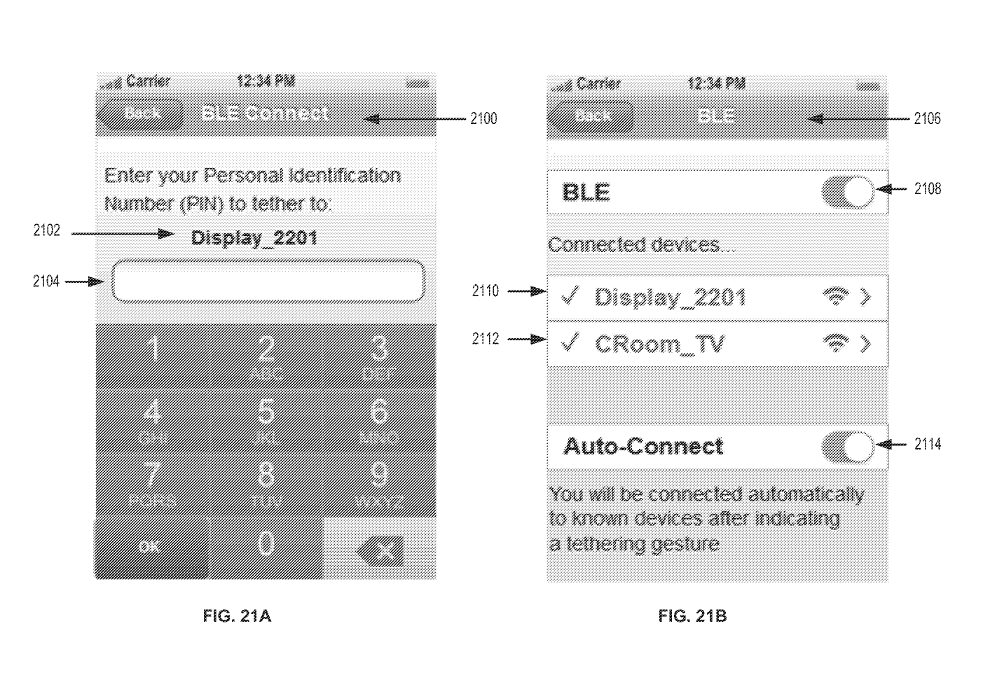

FIGS. 21A and 21B show screenshots from a user interface on a wearable electronic hub device or on a satellite device for tethering the devices and/or for confirming, adjusting, and/or changing communication mechanism settings with respect to a satellite device according to some embodiments. As shown in FIG. 21A, a confirmation screen 2100 (e.g., “BLE Connect”) to tether a hub device to a satellite device may be displayed to a user either on the hub device or on the satellite device. The confirmation screen 2100 may display the name of a satellite device 2102 (e.g., “Display_2201”) to which the hub device is attempting to tether. In addition, the confirmation screen may comprise a text field 2104 for the user to enter his or her PIN as a way to confirm a tethering action. Alternatively, as shown in FIG. 21B, a confirmation screen 2106 may display a tethering mechanism 2108 (e.g., “BLE”) available for instant connection. The confirmation screen may display the name one or more satellite devices 2110, 2112 (e.g., “Display_2201” and “CRoom_TV”) already connected via the tethering mechanism as well as an option 2114 (e.g., a toggle) to automatically connect to known satellite devices based on gesture controls.

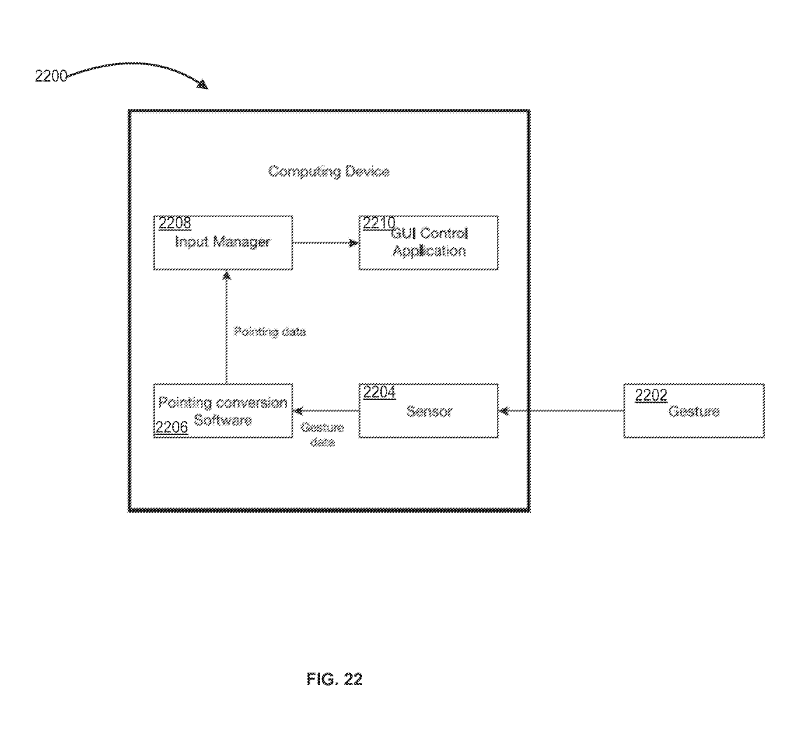

FIG. 22 illustrates a gesture tracking module in a wearable electronic hub device 2200 according to some embodiments. The hub device may detect a gesture 2202 employing a movement sensor 2204 (e.g., an accelerometer and/or a gyroscope enhanced with a compass). The raw data for the gesture 2202 may be sent from the sensor 2204 to a pointing conversion module 2206 to transform the raw data into a readable format for a target application. An input manager 2208 may receive and buffer the pointing data into a GUI Control application 2210 in charge of rendering the manipulation of graphical objects.

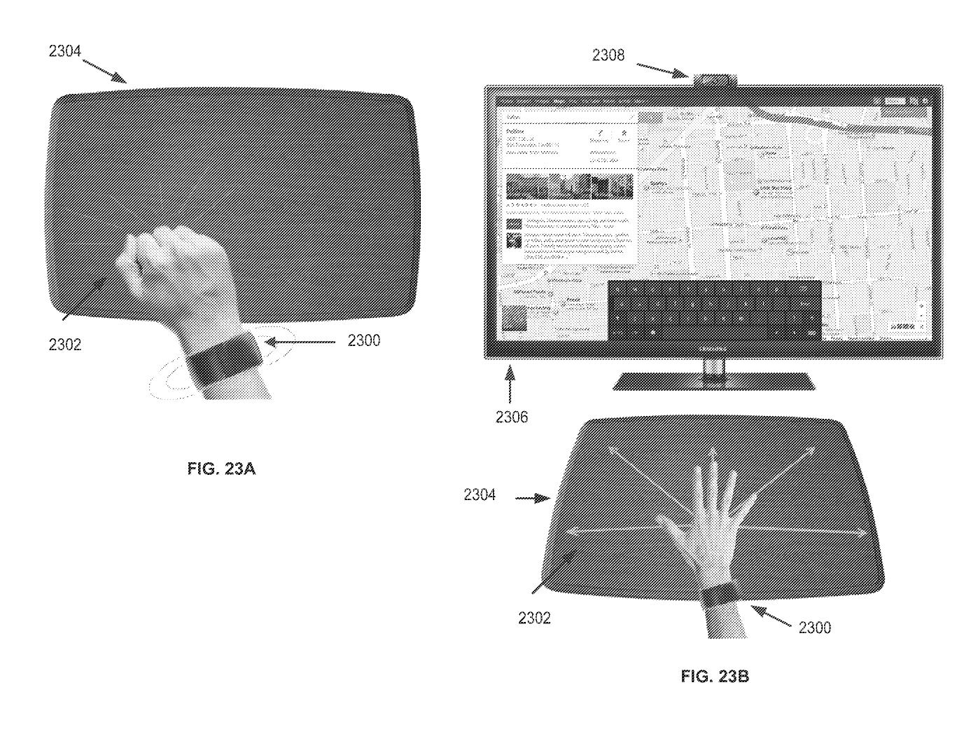

FIGS. 23A and 23B illustrate methods of implementing gesture-based controls, for example, by defining a virtual control surface for data manipulation, according to some embodiments. As shown in FIG. 23A, a wearable electronic hub device 2300 may receive, from a motion sensor disposed therein, an indication of a motion pattern 2302 (e.g., typing motions, finger tapping, finger swiping, finger or palm movements in particular relative or absolute directions, etc.) performed over a surface 2304. Thereafter, the hub device 2300 may analyze a direction of the motion pattern 2302 based on a dimension of a satellite device (including, e.g., a satellite device 2306 paired with the hub device 2300 via a wireless multimedia interface apparatus 2308 connected to the satellite device 2306). In some embodiments, the hub device 2300 may determine that the motion pattern 2302 over the selected surface 2304 indicates a control command (e.g., typing an address to be viewed or a scrolling direction on a map website) based on content displayed on the satellite device 2306.

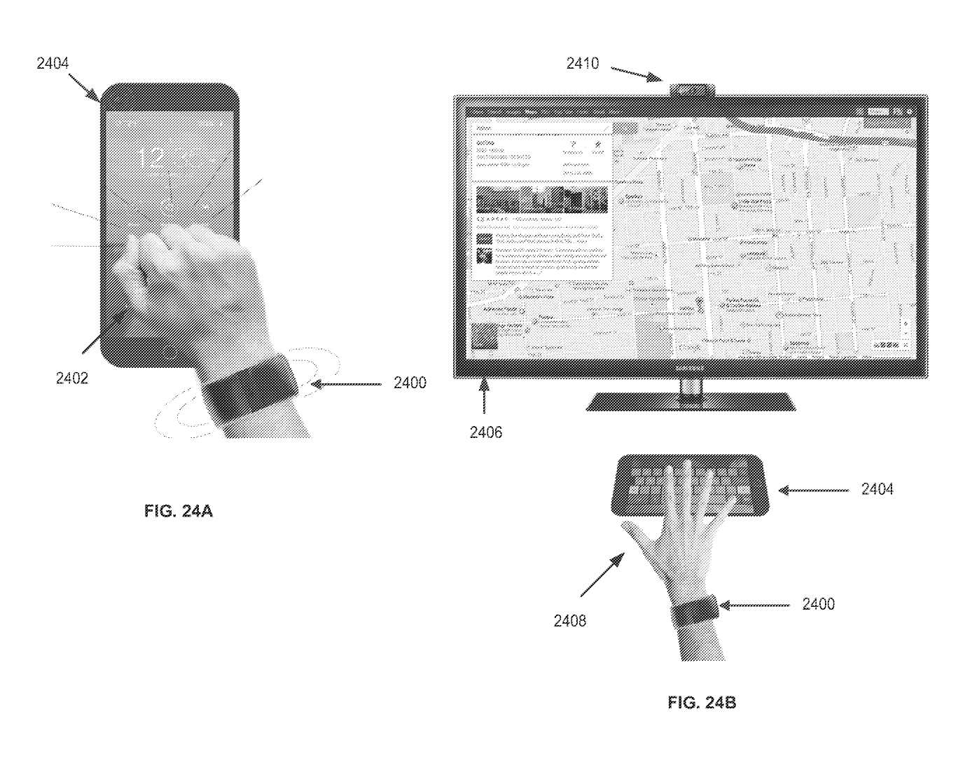

FIG. 24A illustrates motion controlled device tethering between a wearable electronic hub device 2400 and multiple satellite devices according to some embodiments. The hub device 2400 may receive, from a motion sensor disposed therein, an indication of a motion pattern 2402 (e.g., knocking on a satellite device). The hub device 2400 may determine that the motion pattern 2402 indicates a first tethering request.

In some embodiments, the hub device 2400 may instantiate a device query on a communication stack within communication range of the hub device 2400. Thereafter, a wearable electronic hub device 2400 may receive an indication of a first satellite device 2404 and a second satellite device 2406 within the communication stack. Furthermore, a wearable electronic hub device may send a first connection request to the first satellite device 2404 and thereafter it may receive a first connection approval from the first satellite device 2402 in response to the first connection request.

In some embodiments, the hub device 2400 may receive from the motion sensor, an indication of a second motion pattern 2408. The hub device 2400 may determine that the second motion pattern 2408 indicates a second tethering request. The hub device 2400 may send a second connection request to the second satellite device 2406 and thereafter it may receive a second connection approval from the second satellite device 2404 in response to the second connection request.

FIG. 24B illustrates data manipulation on the second tethered satellite device 2406 by employing the first tethered satellite device 2404 and the hub device 2400 according to some embodiments. The hub device 2400 may send data content for display to the first satellite device 2404. In addition, the hub device 2400 may send data content for display to the second satellite device 2406, for example, via a wireless multimedia interface apparatus 2410 coupled with the second satellite device 2406. The hub device 2400 may receive a user input indication from the first satellite device 2404, and process the user input indication to execute a user command. Thereafter, the hub device 2400 may generate output data based on the user command and may send the output data for display to the second satellite device 2406.

A user may configure a wearable electronic hub device to program and customize a motion pattern, via a touch screen UI tethered with a wearable electronic hub device. For example, a user may program and customize a new motion pattern and/or override a preset motion pattern.

In some embodiments, a user may provide a name to identify a motion pattern corresponding to a preset motion pattern, for example, a bump or a motion pattern previously recorded by the user. A user may also configure the number of repetitions of the specified motion pattern that will have to be performed before an action is executed. Similarly, the actions that may be executed after a motion pattern has been detected by a wearable electronic hub device may be specified. For example, the exchange of social profile information, start audio recording, start movement recordings and the like actions. Additionally, a user may want to be notified after the action or actions have been completed.

### Wireless Charging

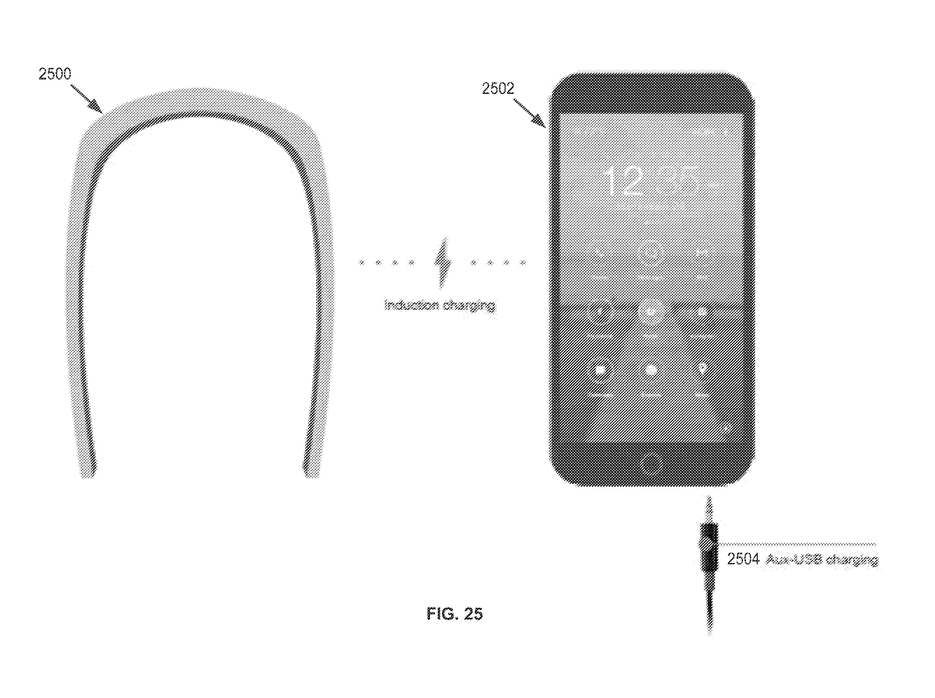

In some embodiments, a wearable electronic hub device may be charged wirelessly, using for example, inductive charging or resonant inductive charging. Inductive charging relies on an electromagnetic field to transfer energy between two objects. FIG. 25 illustrates induction charging between a wearable electronic hub device 2500 and a satellite device 2502 according to some embodiments. Energy is sent through an inductive coupling from the satellite device 2502 to the hub device 2500, which can then use that energy to charge its battery.

Since the hub device 2500 is intended to maximize mobility, only the satellite device 2502 may include a portal for charging 2504 (e.g., Aux-USB) in some embodiments. The satellite device 2502 also may include a first induction coil to create an alternating electromagnetic field. Meanwhile, the hub device 2500 may include a second induction coil to take power from the electromagnetic field and convert it back into electrical current to charge the battery. The two induction coils in proximity combine to form an electrical transformer.

Greater distances between sender and receiver coils can be achieved when the inductive charging system uses resonant inductive coupling to wirelessly transmit energy between two magnetically coupled coils that are part of resonant circuits tuned to resonate at the same frequency. According to some embodiments, a wearable electronic hub device includes a magnetic resonator to receive a flow of power from a magnetic near field induced by a source resonator. A source resonator may be coupled with and/or embedded in a close-range satellite device in order to charge the hub device's battery by magnetic resonant power transfer. In this way, a wearable electronic hub device may take advantage of a close-range satellite device, which is preferably equipped with a larger battery, to charge its battery.

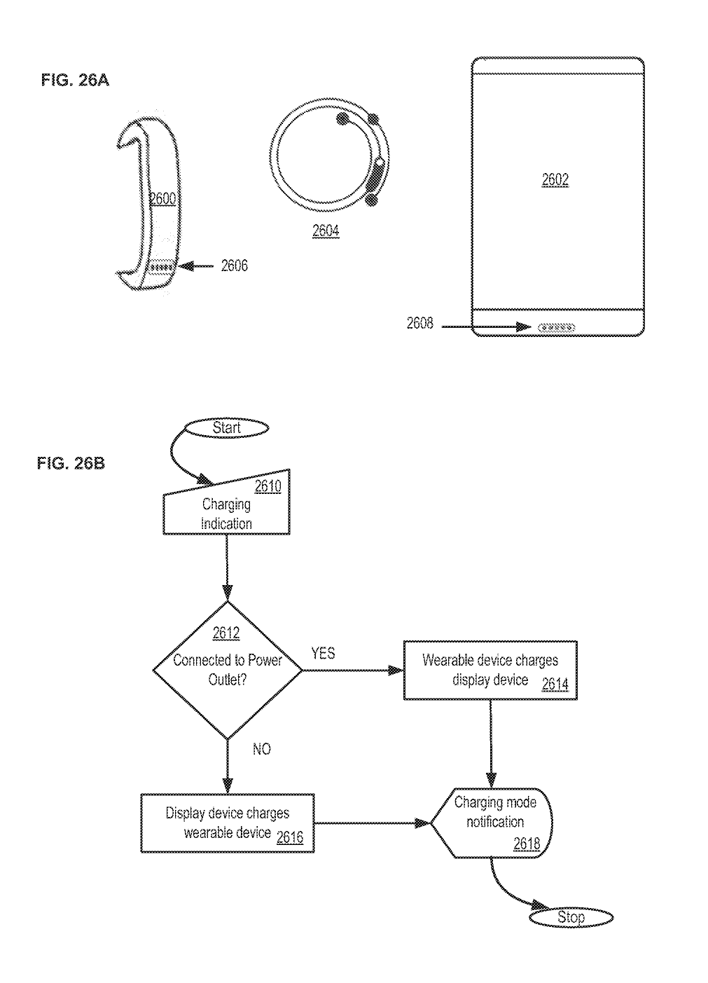

FIG. 26A illustrates a wearable electronic hub device configured for wireless charging according to some embodiments. In FIG. 26A, the wearable electronic hub device 2600 and a satellite device 2602 each include an induction/resonance coil 2604 and electrical connectors 2606 and 2608 respectively, which may attach together by magnetic force. Either device may include additional electrical connectors to connect to external DC and/or AC power supplies.

In some embodiments, a charging mode recognition component comprised by a wearable electronic hub device may determine which device or devices may be powered or charged at a given time when a hub device is electrically and/or magnetically attached to a satellite device. When one of the attached devices emits a charging indication or request, the charging mode recognition component may determine if a wearable electronic hub device is connected to a power outlet or any other external power source. In some embodiments, when a wearable electronic hub device is not connected to a power outlet or any other external power source then the hub device may charge power from the power source comprised by the satellite device. Alternatively, if a wearable electronic hub device is connected to a power outlet or any other external power source, then the hub device may charge the power source comprised by the display device. Furthermore, the charging mode recognition component may notify the user of the hub device of the current charging mode and device or devices charging statuses.

FIG. 26B illustrate a logic flow for charging mode recognition according to some embodiments. In step 2610, a wearable electronic hub device has a charging indication which is processed in step 2612 to determine whether the hub device is connected to an external DC and/or AC power supply. If the hub device is connected, then in step 2614 the charging mode is set such that the hub device charges the satellite device and notification is sent accordingly in step 2618. If the hub device is not connected, then in step 2616 the charging mode is set such that the satellite device charges the hub device and notification is sent accordingly in step 2618.

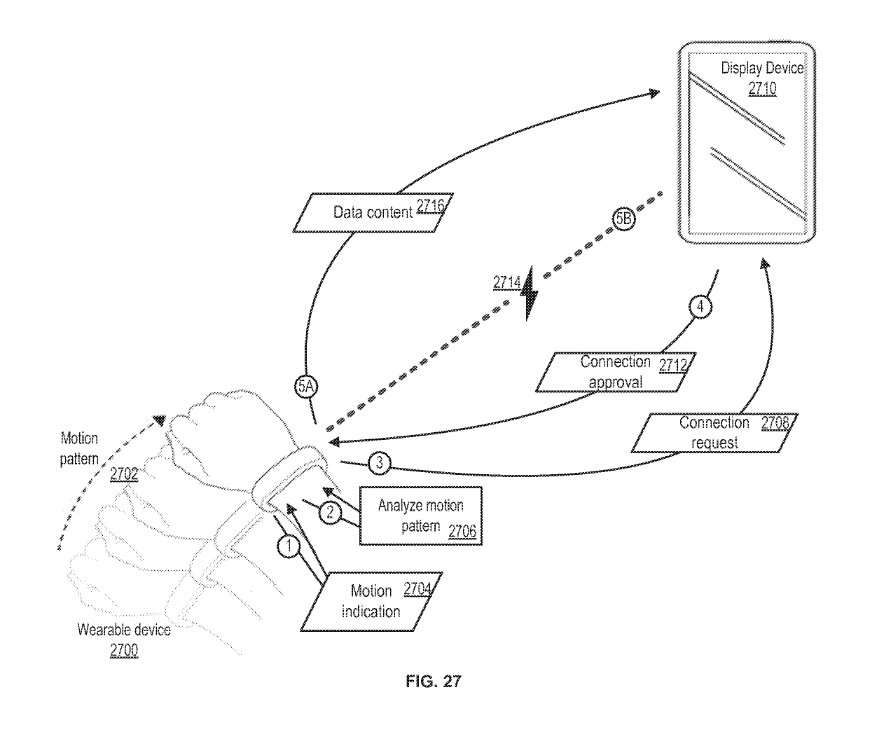

FIG. 27 illustrates a method for wirelessly charging a wearable electronic hub device through magnetic resonance according to some embodiments. In some embodiments, a user wearing a wearable electronic hub device 2700 perform a motion pattern 2702 detected by a motion sensor coupled with and/or embedded in the hub device 3700 to trigger a motion indication 2704. The hub device 2700 performs analysis 2706 to determine whether the motion pattern 2702 matches a preprogrammed motion pattern to command a connection request to a close-range device (e.g., a satellite display device). If a preprogrammed motion pattern is matched, the hub device sends a connection request 2708 to a close-range device 2710. The close-range device 2710 may approve a connection request by sending a connection approval message 2712 to the hub device 2700. The close-range device 2710 may wirelessly transfer power 2714 to the hub device 2700 while, for example, the hub device concurrently transfers (output) data content 2716 to the close-range device 2710. Alternatively or in addition, the hub device 2700 may wirelessly transfer power 2714 to the close-range device 2710 while, for example, the close-range device 2710 transfers (input) data content 2716 to the hub device 2710.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of disclosed herein may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, In some embodiments, to a only (optionally including elements other than B); in another embodiment, to B only (optionally including elements other than a); in yet another embodiment, to both a and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of a and B” (or, equivalently, “at least one of a or B,” or, equivalently “at least one of a and/or B”) can refer, In some embodiments, to at least one, optionally including more than one, a, with no B present (and optionally including elements other than B); in another embodiment, to at least one, optionally including more than one, B, with no a present (and optionally including elements other than a); in yet another embodiment, to at least one, optionally including more than one, a, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A wireless personal computing system, comprising:
at least one dumb wireless satellite device to electronically display visual content and/or electronically sense at least one stimulus or condition, the at least one dumb wireless satellite device comprising:
at least one satellite device communication interface to receive a wireless video signal representing the visual content and/or transmit a wireless sensing signal representing the sensed at least one stimulus or condition;
at least one of:
a display device to display the visual content in response to the wireless video signal; and
at least one sensor to sense the at least one stimulus or condition represented by the wireless sensing signal; and
a satellite memory to cache video information relating to the wireless video signal and/or sensing information relating to the wireless sensing signal; and
a wearable hub computing device to be worn as a personal accessory, the hub computing device comprising:
a housing having a shape to facilitate wearing by and/or contact with a person during operation of the hub computing device;
at least one hub communication interface disposed within the housing to facilitate local wireless communication between the hub computing device and the at least one dumb wireless satellite device;
at least one wide area network interface disposed within the housing to facilitate wide area wireless communication with the hub computing device via at least one wide area network;
at least one battery disposed within the housing to provide power for the hub computing device;
at least one charging system disposed within the housing to wirelessly charge the at least one battery;
at least one hub memory disposed within the housing and storing processor-executable instructions; and
at least one processor, disposed within the housing and communicatively coupled to the at least one hub memory, the at least one hub communication interface, and the at least one wide area network interface, wherein upon execution by the at least one processor of the processor-executable instructions, the at least one processor:
controls the at least one hub communication interface to facilitate a wireless communicative pairing of the at least one dumb wireless satellite device and the hub computing device based at least in part on a proximity of the at least one dumb wireless satellite device to the hub computing device; and after the wireless communicative pairing, controls the at least one hub communication interface to transmit the wireless video signal to the at least one dumb wireless satellite device and/or receive the wireless sensing signal from the at least one dumb wireless satellite device.

2. The system of claim 1, wherein the shape of the housing of the hub computing device facilitates wearing of the hub computing device around a wrist of the person.

3. The system of claim 1, wherein after communicatively decoupling the at least one dumb wireless satellite device and the hub computing device, the satellite memory of the at least one dumb wireless satellite device does not retain the video information relating to the wireless video signal and/or the sensing information relating to the wireless sensing signal, or personal information relating to the person wearing the hub computing device.

4. The system of claim 3, wherein the at least one processor of the hub computing device further controls the at least one hub communication interface to communicatively decouple the at least one dumb wireless satellite device and the hub computing device.

5. The system of claim 1, wherein the at least one processor of the hub computing device: controls the at least one wide area network interface of the hub computing device to
receive from the at least one wide area network first data relating to the visual content;
generates the wireless video signal based on the first data received from the at least one wide area network; and
controls the at least one hub communication interface of the hub computing device to transmit the wireless video signal to the at least one dumb wireless satellite device.

6. The system of claim 1, wherein the at least one processor of the hub computing device: controls the at least one hub communication interface to receive the wireless sensing signal from the at least one dumb wireless satellite device; and
controls the at least one wide area network interface of the hub computing device to transmit to the at least one wide area network second data relating to the sensed at least one stimulus and/or condition represented by the wireless sensing signal.

7. The system of claim 1, wherein the at least one dumb wireless satellite device comprises:
the at least one satellite device communication interface to receive the wireless video signal representing the visual content and transmit the wireless sensing signal representing the sensed at least one stimulus or condition;
the display device to display the visual content in response to the wireless video signal; and
the at least one sensor to sense the at least one stimulus or condition represented by the wireless sensing signal,
wherein the at least one sensor comprises a capacitive touch panel.

8. The system of claim 7, wherein:
the at least one dumb wireless satellite device further comprises a speaker; and
the at least one sensor of the dumb wireless satellite device further comprises a microphone and a camera.

9. The system of claim 8, wherein after communicatively decoupling the at least one dumb wireless satellite device and the hub computing device, the satellite memory of the at least one dumb wireless satellite device does not retain the video information relating to the wireless video signal and/or the sensing information relating to the wireless sensing signal, or personal information relating to the person wearing the hub computing device.

10. A kit comprising the hub computing device and the at least one dumb wireless satellite device of claim 8.

11. The kit of claim 10, wherein the at least one dumb wireless satellite device includes a pocket screen that physically resembles a smartphone.

12. The kit of claim 11, wherein the at least one dumb wireless satellite device includes at least two dumb wireless satellite devices, comprising:
the pocket screen that physically resembles the smartphone; and
a tablet screen that physically resembles a tablet computer.

13. The system of claim 1, wherein the at least one dumb wireless satellite device includes a dongle comprising:
the at least one satellite device communication interface to receive the wireless video signal representing the visual content and transmit the wireless sensing signal representing the sensed at least one stimulus or condition;
the at least one sensor to sense the at least one stimulus or condition represented by the wireless sensing signal, wherein the at least one sensor comprises a camera and a microphone; and
a high definition multimedia interface (HDMI) to transmit the received wireless video signal representing the visual content to a television or a computer monitor display.

14. The system of claim 1, wherein the at least one dumb wireless satellite device includes a plurality of dumb wireless satellite devices comprising:
a first dumb wireless satellite device, comprising:
a first satellite device communication interface to receive a first wireless video signal representing first visual content and/or transmit a first wireless sensing signal representing a first sensed at least one stimulus or condition;
at least one of:
a first display device to display the first visual content in response to the first wireless video signal; and
at least one first sensor to sense the first at least one stimulus or condition represented by the first wireless sensing signal; and
a first satellite memory to cache first video information relating to the first wireless video signal and/or first sensing information relating to the first wireless sensing signal; and
a second dumb wireless satellite device, comprising:
a second satellite device communication interface to receive a second wireless video signal representing second visual content and/or transmit a second wireless sensing signal representing a second sensed at least one stimulus or condition;
at least one of:
a second display device to display the second visual content in response to the second wireless video signal; and
at least one second sensor to sense the second at least one stimulus or condition represented by the second wireless sensing signal; and
a second satellite memory to cache second video information relating to the second wireless video signal and/or second sensing information relating to the second wireless sensing signal.

15. The system of claim 14, wherein the at least one processor of the hub computing device:
controls the at least one hub communication interface to facilitate a first wireless communicative pairing of the first dumb wireless satellite device and the hub computing device based at least in part on a first proximity of the first dumb wireless satellite device to the hub computing device;
after the first wireless communicative pairing, controls the at least one hub communication interface to transmit the first wireless video signal to the first dumb wireless satellite device and/or receive the first wireless sensing signal from the first dumb wireless satellite device;
controls the at least one hub communication interface to facilitate a second wireless communicative pairing of the second dumb wireless satellite device and the hub computing device based at least in part on a second proximity of the second dumb wireless satellite device to the hub computing device; and
after the second wireless communicative pairing, controls the at least one hub communication interface to transmit the second wireless video signal to the second dumb wireless satellite device and/or receive the second wireless sensing signal from the second dumb wireless satellite device.

16. The system of claim 15, wherein:
the first dumb wireless satellite device comprises:
the first satellite device communication interface to receive the first wireless video signal representing the first visual content and transmit the first wireless sensing signal representing the first sensed at least one stimulus or condition;
the first display device to display the first visual content in response to the first wireless video signal; and
the at least one first sensor to sense the first at least one stimulus or condition represented by the first wireless sensing signal, wherein the at least one sensor comprises a capacitive touch panel; and
the second dumb wireless satellite device is a dongle comprising:
the second satellite device communication interface to receive the second wireless video signal representing the second visual content and transmit the second wireless sensing signal representing the second sensed at least one stimulus or condition;
the at least one second sensor to sense the second at least one stimulus or condition represented by the second wireless sensing signal, wherein the at least one second sensor comprises a camera and a microphone; and
a high definition multimedia interface (HDMI) to transmit the received second wireless video signal representing the second visual content to a television or a computer monitor display.

17. The system of claim 16, wherein, upon execution of the processor-executable instructions, the at least one processor of the at least one hub computing device generates the second wireless video signal representing the second visual content for the television or the computer monitor display based at least in part on the first wireless sensing signal received from the first dumb wireless satellite device and representing the first sensed at least one stimulus or condition.

18. A kit comprising the hub computing device, the first dumb wireless satellite device, and the dongle of claim 16.

19. The system of claim 1, wherein the wearable hub computing device further comprises at least one hub sensor disposed within the housing to facilitate sensing of at least one motion of the hub computing device.

20. The system of claim 19, wherein the at least one hub sensor includes at least one of:
an accelerometer;
a gyroscope; and
a digital compass.

21. The system of claim 19, wherein upon execution of the processor-executable instructions by the at least one processor of the hub computing device, the at least one processor further:
monitors the at least one hub sensor to detect a first motion of the hub computing device corresponding to a first gesture of the person; and
controls the at least one hub communication interface to facilitate the wireless communicative pairing of the at least one dumb wireless satellite device and the hub computing device based at least in part on the proximity of the at least one dumb wireless satellite device to the hub computing device and the first detected motion corresponding to the first gesture of the person.

22. The system of claim 21, wherein:
the shape of the housing of the hub computing device facilitates wearing of the hub computing device around a wrist of the person;
the first gesture of the person includes knocking by the person on a surface using a hand coupled to the wrist on which the hub computing device is worn; and
the detected first motion corresponds to the knocking by the person.

23. The system of claim 19, wherein upon execution of the processor-executable instructions by the at least one processor of the hub computing device, the at least one processor further:
monitors the at least one hub sensor to detect at least one motion of the hub computing device corresponding to at least one movement of the person wearing the hub computing device;
generates the wireless video signal based at least in part on the detected at least one motion corresponding to the at least one movement of the person; and
controls the at least one hub communication interface to transmit the wireless video signal to the at least one dumb wireless satellite device such that the visual content displayed on the at least one dumb satellite device is based at least in part on the detected at least one motion.

24. The system of claim 23, wherein:
the shape of the housing of the hub computing device facilitates wearing of the hub computing device around a wrist of the person; and
the at least one movement of the person includes moving a hand coupled to the wrist on which the hub computing device is worn in at least one direction across a surface.

25. The system of claim 23, wherein:
the shape of the housing of the hub computing device facilitates wearing of the hub computing device around a wrist of the person; and
the at least one movement of the person includes typing on a surface using fingers of a hand coupled to the wrist on which the hub computing device is worn.

26. The system of claim 1, wherein the at least one wide area network interface of the hub computing device is configured to facilitate the wide area wireless communication with the hub computing device via the at least one wide area network using one of a 2G, 3G, 4G, and LTE mobile communication technology.

27. The system of claim 1, wherein the at least one hub communication interface of the hub computing device is configured to facilitate the local wireless communication between the hub computing device and the at least one dumb wireless satellite device using at least one of a Bluetooth™, BTLE, Wi-Fi, WiGig, and NFC wireless communication technology.

28. The system of claim 1, wherein the hub computing device further comprises a GPS device.

29. The system of claim 1, wherein the hub computing device further comprises a display.

30. The system of claim 1, wherein the at least one charging system of the hub computing device includes one of an inductive charging system and a magnetic resonance charging system.

31. The system of claim 1, wherein the hub computing device further comprises a microphone and a speaker.

32. The system of claim 1, wherein:
the hub computing device includes a flexible printed circuit board assembly;
the at least one wide area network interface of the hub computing device is disposed on the flexible printed circuit board assembly between the at least one charging system of the hub computing device and integrated circuitry comprising the at least one hub memory and the at least one processor of the hub computing device; and
the integrated circuitry is disposed on the flexible printed circuit board assembly between the at least one wide area network interface and the at least one hub communication interface.

33. A wearable hub computing device to be worn as a personal accessory, the hub computing device comprising:
a housing having a shape to facilitate wearing by and/or contact with a person during operation of the hub computing device;
at least one local communication interface disposed within the housing to facilitate local wireless communication between the hub computing device and at least one dumb wireless satellite apparatus;
at least one wide area network interface disposed within the housing to facilitate wide area wireless communication with the hub computing device via at least one wide area network;
at least one battery disposed within the housing to provide power for the hub computing device;
at least one charging system disposed within the housing to wirelessly charge the at least one battery;
at least one hub memory disposed within the housing and storing processor-executable instructions; and
at least one processor, disposed within the housing and communicatively coupled to the at least one hub memory, the at least one local communication interface, and the at least one wide area network interface, wherein upon execution by the at least one processor of the processor-executable instructions, the at least one processor:
controls the at least one local communication interface to facilitate a wireless communicative pairing of the at least one dumb wireless satellite device and the hub computing device based at least in part on a proximity of the at least one dumb wireless satellite device to the hub computing device; and
after the wireless communicative pairing, controls the at least one local communication interface to transmit a wireless video signal to the at least one dumb wireless satellite device representing visual content for display on the at least one dumb wireless satellite device and/or receive a wireless sensing signal from the at least one dumb wireless satellite device representing at least one stimulus or condition sensed by the at least one dumb wireless satellite device.

34. The wearable hub computing device of claim 33, wherein the shape of the housing of the hub computing device facilitates wearing of the hub computing device around a wrist of the person.

35. The wearable hub computing device of claim 33, wherein upon execution of the processor-executable instructions, the at least one processor of the hub computing device further controls the at least one hub communication interface to communicatively decouple the at least one dumb wireless satellite device and the hub computing device.

36. The wearable hub computing device of claim 33, wherein upon execution of the processor-executable instructions, the at least one processor of the hub computing device further:
controls the at least one wide area network interface of the hub computing device to receive from the at least one wide area network first data relating to the visual content;
generates the wireless video signal based on the first data received from the at least one wide area network; and
controls the at least one hub communication interface of the hub computing device to transmit the wireless video signal to the at least one dumb wireless satellite device.

37. The wearable hub computing device of claim 33, wherein upon execution of the processor-executable instructions, the at least one processor of the hub computing device:
controls the at least one hub communication interface to receive the wireless sensing signal from the at least one dumb wireless satellite device; and
controls the at least one wide area network interface of the hub computing device to transmit to the at least one wide area network second data relating to the sensed at least one stimulus and/or condition represented by the wireless sensing signal.

38. The wearable hub computing device of claim 33, wherein the at least one dumb wireless satellite device includes a plurality of dumb wireless satellite devices comprising:
a first dumb wireless satellite device, comprising:
a first satellite device communication interface to receive a first wireless video signal representing first visual content and/or transmit a first wireless sensing signal representing a first sensed at least one stimulus or condition;
at least one of:
a first display device to display the first visual content in response to the first wireless video signal; and
at least one first sensor to sense the first at least one stimulus or condition represented by the first wireless sensing signal; and
a first satellite memory to cache first video information relating to the first wireless video signal and/or first sensing information relating to the first wireless sensing signal; and
a second dumb wireless satellite device, comprising:
a second satellite device communication interface to receive a second wireless video signal representing second visual content and/or transmit a second wireless sensing signal representing a second sensed at least one stimulus or condition;
at least one of:
a second display device to display the second visual content in response to the second wireless video signal; and
at least one second sensor to sense the second at least one stimulus or condition represented by the second wireless sensing signal; and
a second satellite memory to cache second video information relating to the second wireless video signal and/or second sensing information relating to the second wireless sensing signal,
and wherein upon execution of the processor-executable instructions, the at least one processor of the hub computing device:
controls the at least one hub communication interface to facilitate a first wireless communicative pairing of the first dumb wireless satellite device and the hub computing device based at least in part on a first proximity of the first dumb wireless satellite device to the hub computing device;
after the first wireless communicative pairing, controls the at least one hub communication interface to transmit the first wireless video signal to the first dumb wireless satellite device and/or receive the first wireless sensing signal from the first dumb wireless satellite device;
controls the at least one hub communication interface to facilitate a second wireless communicative pairing of the second dumb wireless satellite device and the hub computing device based at least in part on a second proximity of the second dumb wireless satellite device to the hub computing device; and
after the second wireless communicative pairing, controls the at least one hub communication interface to transmit the second wireless video signal to the second dumb wireless satellite device and/or receive the second wireless sensing signal from the second dumb wireless satellite device.

39. The wearable hub computing device of claim 38, wherein:
the first dumb wireless satellite device comprises:
the first satellite device communication interface to receive the first wireless video signal representing the first visual content and transmit the first wireless sensing signal representing the first sensed at least one stimulus or condition;
the first display device to display the first visual content in response to the first wireless video signal; and
the at least one first sensor to sense the first at least one stimulus or condition represented by the first wireless sensing signal, wherein the at least one sensor comprises a capacitive touch panel; and
the second dumb wireless satellite device is a dongle comprising:
the second satellite device communication interface to receive the second wireless video signal representing the second visual content and transmit the second wireless sensing signal representing the second sensed at least one stimulus or condition;
the at least one second sensor to sense the second at least one stimulus or condition represented by the second wireless sensing signal, wherein the at least one second sensor comprises a camera and a microphone; and
a high definition multimedia interface (HDMI) to transmit the received second wireless video signal representing the second visual content to a television or a computer monitor display,
and wherein, upon execution of the processor-executable instructions, the at least one processor of the at least one hub computing device generates the second wireless video signal representing the second visual content for the television or the computer monitor display based at least in part on the first wireless sensing signal received from the first dumb wireless satellite device and representing the first sensed at least one stimulus or condition.

40. The wearable hub computing device of claim 33, further comprising at least one hub sensor disposed within the housing to facilitate sensing of at least one motion of the hub computing device.

41. The wearable hub computing device of claim 40, wherein the at least one hub sensor includes at least one of:
an accelerometer;
a gyroscope; and
a digital compass.

42. The wearable hub computing device of claim 40, wherein upon execution of the processor-executable instructions by the at least one processor of the hub computing device, the at least one processor further:
monitors the at least one hub sensor to detect a first motion of the hub computing device corresponding to a first gesture of the person; and
controls the at least one hub communication interface to facilitate the wireless communicative pairing of the at least one dumb wireless satellite device and the hub computing device based at least in part on the proximity of the at least one dumb wireless satellite device to the hub computing device and the first detected motion corresponding to the first gesture of the person.

43. The wearable hub computing device of claim 42, wherein:
the shape of the housing of the hub computing device facilitates wearing of the hub computing device around a wrist of the person;
the first gesture of the person includes knocking by the person on a surface using a hand coupled to the wrist on which the hub computing device is worn; and
the detected first motion corresponds to the knocking by the person.

44. The wearable hub computing device of claim 40, wherein upon execution of the processor-executable instructions by the at least one processor of the hub computing device, the at least one processor further:
monitors the at least one hub sensor to detect at least one motion of the hub computing device corresponding to at least one movement of the person wearing the hub computing device;
generates the wireless video signal based at least in part on the detected at least one motion corresponding to the at least one movement of the person; and
controls the at least one hub communication interface to transmit the wireless video signal to the at least one dumb wireless satellite device such that the visual content displayed on the at least one dumb satellite device is based at least in part on the detected at least one motion.

45. The wearable hub computing device of claim 44, wherein:
the shape of the housing of the hub computing device facilitates wearing of the hub computing device around a wrist of the person; and
the at least one movement of the person includes moving a hand coupled to the wrist on which the hub computing device is worn in at least one direction across a surface.

46. The wearable hub computing device of claim 44, wherein:
the shape of the housing of the hub computing device facilitates wearing of the hub computing device around a wrist of the person; and
the at least one movement of the person includes typing on a surface using fingers of a hand coupled to the wrist on which the hub computing device is worn.

47. The wearable hub computing device of claim 33, wherein the at least one wide area network interface of the hub computing device is configured to facilitate the wide area wireless communication with the hub computing device via the at least one wide area network using one of a 2G, 3G, 4G, and LTE mobile communication technology.

48. The wearable hub computing device of claim 33, wherein the at least one hub communication interface of the hub computing device is configured to facilitate the local wireless communication between the hub computing device and the at least one dumb wireless satellite device using at least one of a Bluetooth™, BTLE, Wi-Fi, WiGig, and NFC wireless communication technology.

49. The wearable hub computing device of claim 33, further comprising a GPS device.

50. The wearable hub computing device of claim 33, further comprising a display.

51. The wearable hub computing device of claim 33, wherein the at least one charging system of the hub computing device includes one of an inductive charging system and a magnetic resonance charging system.

52. The wearable hub computing device of claim 33, further comprising a microphone and a speaker.

53. The wearable hub computing device of claim 33, wherein:
the hub computing device includes a flexible printed circuit board assembly;
the at least one wide area network interface of the hub computing device is disposed on the flexible printed circuit board assembly between the at least one charging system of the hub computing device and integrated circuitry comprising the at least one hub memory and the at least one processor of the hub computing device; and
the integrated circuitry is disposed on the flexible printed circuit board assembly between the at least one wide area network interface and the at least one hub communication interface.

54. A hub computing apparatus to be worn as a personal accessory, the apparatus comprising:
a housing having a shape to facilitate wearing by and/or contact with a person during operation of the apparatus;
at least one sensor disposed within the housing to facilitate sensing of at least one motion of the apparatus;
at least one communication interface disposed within the housing to facilitate wireless communication between the apparatus and at least one dumb display device;
at least one battery disposed within the housing to provide power for the apparatus;
at least one charging system disposed within the housing to wirelessly charge the at least one battery;
at least one memory storing processor-executable instructions; and
at least one processor, communicatively coupled to at least the at least one sensor, the at least one memory and the at least one communication interface, wherein upon execution by the at least one processor of the processor-executable instructions, the at least one processor:
A) monitors the at least one sensor to detect a first motion of the apparatus corresponding to a first gesture of the person; and
B) controls the at least one communication interface to establish a first wireless communication link between the apparatus and the at least one dumb display device based at least in part on the first detected motion.

55. The hub computing apparatus of claim 54, wherein:
the shape of the housing facilitates wearing of the apparatus around a wrist of the person;
the first gesture of the person includes knocking by the person on the at least one dumb display device using a hand coupled to the wrist on which the apparatus is worn; and
the detected first motion corresponds to the knocking by the person.

56. A system, comprising:
the hub computing apparatus of claim 54; and
the at least one dumb display device wirelessly coupled to the hub computing apparatus.

57. The system of claim 56, wherein the at least one dumb display device includes:
a touch panel to facilitate user input; and
at least one second communication interface to facilitate wireless communication of:
video signals from the hub computing apparatus to the at least one dumb display device; and
at least one signal representing the user input from the at least one dumb display device to the hub computing apparatus.

58. The system of claim 56, further comprising a dongle to wirelessly receive video and audio signals from the hub computing device and transmit the received video and audio signals, via a high definition multimedia interface (HDMI), to a television or computer monitor.

59. A kit, comprising:
the hub computing apparatus of claim 54; and
the at least one dumb display device.

60. The kit of claim 59, further comprising a dongle to wirelessly receive video and audio signals from the hub computing device and transmit the received video and audio signals, via a high definition multimedia interface (HDMI), to a television or computer monitor.

61. A hub computing apparatus to be worn as a personal accessory, the apparatus comprising:
a housing having a shape to facilitate wearing by and/or contact with a person during operation of the apparatus;
at least one communication interface disposed within the housing to facilitate wireless communication between the apparatus and at least one peripheral device;
at least one battery disposed within the housing to provide power for the apparatus;
at least one charging system disposed within the housing to wirelessly charge the at least one battery;
at least one memory storing processor-executable instructions; and
at least one processor, communicatively coupled to at least the at least one sensor, the at least one memory and the at least one communication interface, wherein upon execution by the at least one processor of the processor-executable instructions, the at least one processor:
controls the at least one communication interface to establish a first wireless communication link between the apparatus and the at least one peripheral device based at least in part on a proximity of the at least one peripheral device to the hub computing apparatus.

62. The hub computing apparatus of claim 61, wherein the shape of the housing facilitates wearing of the apparatus around a wrist of the person.

63. The hub computing apparatus of claim 61, wherein the at least one peripheral device includes:
a touch panel to facilitate user input; and
at least one second communication interface to facilitate wireless communication of at least one signal representing the user input from the at least one peripheral device to the hub computing apparatus.

64. A system comprising:
the hub computing apparatus of claim 61; and
the at least one peripheral device,
wherein the at least one peripheral device includes a dongle to wirelessly receive video and audio signals from the hub computing device and transmit the received video and audio signals, via a high definition multimedia interface (HDMI), to a television or computer monitor.

65. A wearable electronic computing hub device for wirelessly coupling with an electronic satellite device, the hub device comprising:
a wireless communication interface to wirelessly couple the hub device to the satellite device;
at least one memory for storing processor-executable instructions and user data; and
at least one processor communicatively coupled to the wireless communication interface and the memory, wherein upon execution of the processor-executable instructions by the at least one processor, the at least one processor:
controls the wireless communication interface to:
wirelessly couple with the satellite device, the satellite device comprising a touch screen;
operate a graphical user interface for display on the touch screen; and
receive at least one distinct signal from the satellite device, the at least one distinct signal being generated by the satellite device to represent at least one location of at least one touch that occurs in a plane of the touch screen; and
processes the at least one distinct signal,
wherein upon decoupling the hub device from the satellite device, the hub device stores at least some of the user data while the satellite device is incapable of retaining any of the user data, the user data including the at least one distinct signal.

66. A wearable electronic computing hub device for wirelessly coupling with an interchangeable electronic satellite device, the hub device comprising:
a wristband to be worn on the wrist of a user;
a wireless communication interface to wirelessly couple the hub device to the satellite device;
at least one memory for storing processor-executable instructions and user data; and
at least one processor communicatively coupled to the first wireless communication interface and the memory, wherein upon execution of the processor-executable instructions by the at least one processor, the at least one processor:
controls the wireless communication interface to:
wirelessly couple with the satellite device based at least in part on a proximity of the satellite device, the satellite device comprising a touch screen;
operate a graphical user interface for display on the touch screen; and
receive at least one distinct signal from the satellite device, the at least one distinct signal being generated by the satellite device to represent at least one location of at least one touch that occurs in a plane of the touch screen; and
processes the at least one distinct signal,
wherein upon decoupling the hub device from the satellite device, the hub device retains at least some of the user data while the satellite device is incapable of retaining any of the user data, the user data including the at least one distinct signal.

67. An electronic satellite device for wirelessly coupling with a wearable electronic computing hub device, the satellite device comprising:
a wireless communication interface to wirelessly couple the satellite device to the hub device; and
a touch screen, wherein upon wirelessly coupling the satellite device with the hub device, the satellite device:
displays on the touch screen a graphical user interface operated, via the wireless communication interface, by the hub device;
detects at least one touch that occurs in a plane of the touch screen;
generates at least one distinct signal representative of at least one location of the at least one touch in the plane of the touch screen for each of the at least one touch; and
transmits the at least one distinct signal to the hub device via the wireless communication interface, such that the hub device processes the at least one distinct signal,
wherein upon decoupling the satellite device from the hub device, the hub device retains user data while the satellite device is incapable of retaining any of the user data, the user data including the at least one distinct signal.

68. A system for personal computing, the system comprising:
a wearable electronic computing hub device, comprising:
a first wireless communication interface;
at least one memory for storing processor-executable instructions and user data; and
at least one processor communicatively coupled to the first wireless communication interface and the at least one memory; and
an electronic satellite device for wirelessly coupling with the hub device, the satellite device comprising:
a touch screen; and
a second wireless communication interface to wirelessly couple the satellite device to the hub device, via the first wireless communication interface,
wherein upon execution of the processor-executable instructions by the at least one processor, the at least one processor controls the first wireless communication interface to wirelessly couple the hub device and the satellite device such that the satellite device:
displays on the touch screen a graphical user interface operated by the hub device;
detects at least one touch that occurs in a plane of the touch screen;
generates at least one distinct signal representative of at least one location of the at least one touch in the plane of the touch screen for each of the at least one touch; and
transmits the at least one distinct signal to the hub device, such that the hub device processes the at least one distinct signal,
wherein upon decoupling the hub device from the satellite device, the hub device stores at least some of the user data while the satellite device is incapable of retaining any of the user data, the user data including the at least one distinct signal.

69. A wrist-wearable apparatus, comprising:
a wrist-band shaped body;
a digital display, visible via an outer surface of the wrist-band shaped body, to display a current time and a notification label;
a motion sensor, disposed within the wrist-band shaped body, to detect movement of the wrist-band shaped-body;
a vibration motor, disposed within the wrist-band shaped body, to vibrate the wrist-band shaped body;
a wireless communication transceiver, disposed within the wrist-band shaped body, to receive a communication request;
a processor disposed within the wrist-band shaped body and operably coupled to the digital display, the motion sensor, the vibration motor, and the wireless communication transceiver; and
a memory disposed in communication with the processor and storing processor-executable instructions to:
receive the communication request via the wireless communication transceiver;
determine a type of the communication request;
generate the notification label based on the type of the communication request for display at the digital display;
determine a vibration pattern based on the type of the communication request for the vibration motor to vibrate the wrist-band shaped body according to the vibration pattern;
determine the movement detected by the motion sensor indicates a control command in response to the notification label and the vibration notification; and
execute the control command.

70. The wrist-wearable apparatus of claim 69, further comprising:
a power supply, operably coupled to the processor, to provide electrical power to the processor; and
a coil, operably coupled to the power supply, to recharge the power supply via magnetic resonance.

71. A processor-implemented method for motion controlled device tethering, the method comprising:
receiving, from a motion sensor in a wearable personal mobile device, a motion indication including a movement pattern of the wearable personal mobile device;
determining, based at least part on the motion indication, that the movement pattern indicates a tethering request to tether the wearable personal mobile device with a user interface output device;
instantiating a device query on a communication stack within communication range of the wearable personal mobile device in response to the tethering request;
receiving, via a wireless transceiver in the wearable personal mobile device, an indication of the user interface output device within the communication stack in response to the device query;
sending, via the wireless transceiver, a connection request to the display device;
receiving, via the wireless transceiver, a connection approval from the display device in response to the connection request; and
sending, via the wireless transceiver, data content to the user interface output device for presenting to a user.

72. The method of claim 71, wherein the user interface output device includes an audio speaker.

73. The method of claim 71, wherein the user interface output device includes a display device.

74. The method of claim 73, further comprising:
receiving, from the motion sensor, a second motion indication including a second movement pattern;
analyzing a direction of the second movement pattern based on a dimension of the display device;
determining the second movement pattern indicates a control command based on displayed content on the display device; and
executing the control command.

75. A processor-implemented method for motion controlled device tethering, comprising:
receiving, from a motion sensor in a wearable personal mobile device, a first motion indication including a first movement pattern;
determining the first movement pattern indicates a first tethering request;
instantiating a device query on a communication stack within communication range of the wearable personal mobile device;
receiving an indication of a first display device and a second display device within the communication stack;
sending a first connection request from the wearable personal mobile device to the first display device;
receiving a first connection approval by the wearable personal mobile device from the first display device in response to the first connection request;
sending data content for display from the wearable personal mobile device to the first display device;
receiving, from the motion sensor, a second motion indication including a second movement pattern;
determining the second movement pattern indicates a second tethering request;
sending a second connection request from the wearable personal mobile device to the second display device;
receiving a second connection approval by the wearable personal mobile device from the second display device in response to the second connection request; and
sending the data content for display from the wearable personal mobile device to the second display device.

76. The method of claim 75, further comprising:
receiving a user input indication from the first display device;
processing the user input indication to execute a user command;
generating output data based on the executing the user command; and
sending the output data for display to the second display device.

77. A processor-implemented method for motion controlled device tethering, the method comprising:
instantiating a device query on a communication stack within a communication range of a personal wearable device comprising a wireless transceiver operably coupled to a processor; receiving, via the wireless transceiver, an indication of a home electronics device from the home electronics device within in the communication stack;
obtaining a device identifier from the indication of the home electronics device;
querying a list of pre-stored device identifiers for the device identifier to determine a type of the home electronics device;
configuring a control interface based on the type of the home electronics device;
sending a control command based on the configured control interface to the home electronics device; and
receiving, from the home electronics device, a notification indicative of the operating status of the home electronics device in response to the control command.

78. A hardware authentication processor-implemented method, comprising:
receiving, from a user service provider, a user credential verification request including a hardware identifier associated with an intelligent wearable device, wherein the user credential verification request is originated in response to an access request to user specific content stored at the user service provider, the access request being originated from the intelligent wearable device;
verifying the hardware identifier based on pre-stored user profile information; and
sending a user credential verification response to the user service provider, wherein the user credential verification response indicates the access request is authenticated.

79. A hardware authentication system, comprising:
a wearable user device having a hardware identifier, the wearable user device being configured to:
send, to a user service provider, an access request to user specific content stored at the user service provider, and
receive an approval to access the user specific content when the access request is granted by the user service provider; and
a server, including:
a processor, and
a memory disposed in communication with the processor and storing processor-executable instructions to:
receive, from the user service provider, a user credential verification request including the hardware identifier,
verify the hardware identifier based on pre-stored user profile information; and
send a user credential verification response to the user service provider, wherein the user credential verification response indicates the access request is authenticated.

80. A processor-implemented method for hardware identification based targeted ad delivery, the method comprising:
receiving, from a remote computing device at a remote location, a plurality of hardware identifiers, each hardware identifier in the plurality of hardware identifiers being associated with a corresponding personal mobile device;
retrieving a corresponding user interests profile associated with each hardware identifier in the plurality of hardware identifiers;
determining a common interest indicator of all user interests profiles associated with the plurality of the hardware identifiers;
sending the common interest indicator to the remote computing device at the remote location; and
selecting, by the remote computing device, an advertisement for display at the remote location based on the common interest indicator.

81. A wireless multimedia interface apparatus, comprising:
a body member having a size of a thumb drive;
a wireless transceiver, disposed within the body member, to receive data content via a wireless connection from a computing device;
a multimedia data format converter, disposed within the body member and communicatively coupled to the wireless transceiver, to convert a data format of the data content to a multimedia format compatible for display at a screen display device; and
a multimedia interface connector, communicatively coupled to the multimedia data format converter, to be plugged into a multimedia input receptacle of the screen display device and to transmit the data content in the multimedia format to the screen display for display.

82. A processor-implemented method for motion controlled device tethering, the method comprising:
receiving, from a motion sensor disposed within a first wearable computing device, a first motion indication representative of a first movement pattern of the first wearable computing device;
determining that the first movement pattern indicates a first tethering request for tethering the first wearable computing device to a first display device;
instantiating a device query on a communication stack within communication range of the first wearable computing device;
receiving an indication of a first display device and a second display device in the communication stack;
sending a first connection request from the first wearable computing device to the display device;
establishing a first wireless connection between the first wearable computing device and the display device in response to the first connection request;
receiving a second connection request from a second wearable computing device;
establishing a second wireless connection with the second wearable computing device in response to the second connection request;
instantiating, an application component allowing multiple control inputs, on the first wearable computing device;
receiving, a first user input control command via a user interface of the first wearable computing device;
receiving, a second user input control command via the second wireless connection, from the second wearable computing device;
engaging the application component with both the first user input control command and the second user input control command; and
sending, via the first wireless connection, real-time updated data content generated based on both the first user input control command and the second user input control command to the display device for display.

83. A system, comprising:
a display device, including:
a display screen;
a first power supply unit, disposed within the display device, to be recharged via magnetic resonance charging; and
a wearable device, including:
a housing member;
a motion sensor, disposed with the housing member, to detect movement of the wrist-band shaped-body;
a second power supply unit, disposed within the housing member, to be recharged via wireless charging;
a wireless communication transceiver, disposed within the housing member, to receive a communication request;
a processor disposed within the housing member and operably coupled to the motion sensor, the second power supply unit, and the wireless communication transceiver; and
a memory disposed in communication with the processor and storing processor-executable instructions to:
receive, from a motion sensor in a wearable device, a motion indication of a movement pattern of the wearable device;
determine, based at least part on the motion indication, that the movement pattern indicates a tethering request to tether the wearable device with the display device;
send, via the wireless transceiver, a connection request to the display device;
receive, via the wireless transceiver, a connection approval from the display device in response to the connection request;
send, via the wireless transceiver, data content to the display device for presenting the data content on the display screen; and
receive, via wireless charging upon connection with the display device, a supply of power from the first power supply unit to recharge the second power supply unit.

84. The system of claim 83, wherein the wireless charging includes magnetic resonance charging.

85. The system of claim 83, wherein the display device is separate from the wearable device, and the display screen includes a touch screen panel.

86. A processor-implemented method for motion controlled device tethering, the method comprising:
establishing, via a wireless transceiver in a wearable personal mobile device, a first communication link with a first user interface output device and a second communication link with a second user interface output device;
determining a first type of the first user interface output device and a second type of the second user interface output device;
obtaining pre-stored privacy configuration parameters associated with the first type and the second type; and
sending first data content to the first user interface output device and second data content to the second user interface output device based on the pre-stored privacy configuration parameters.

87. The method of claim 86, wherein the pre-stored privacy configuration parameters are submitted by a user via a user interface.

88. A system, comprising:
a display device, including:
a display screen;
a first power supply unit, disposed within the display device, to be recharged via magnetic resonance charging; and
a wearable device, including:
a housing member;
a second power supply unit, disposed within the housing member, to be recharged via magnetic resonance charging; and
a power supply input port on the surface of the housing member, to be connected to a power supply source;
wherein when the wearable device is in contact with the display device and when the power supply input port is connected to the power supply source, the second power supply unit charges the first power supply unit via magnetic resonance charging;
wherein when the wearable device is in contact with the display device and when the power supply input port is disconnected from the power supply source, the first power supply unit charges the second power supply unit via magnetic resonance charging.
